(19) United States
(12) Patent Application Publication
(10) Pub. No.: US 2019/0145765 A1
(43) Pub. Date: May 16, 2019

(54) Three Dimensional Object Detection

(71) Applicant: Uber Technologies, Inc., San Francisco, CA (US)

(72) Inventors: Wenjie Luo, Toronto (CA); Bin Yang, Toronto (CA); Raquel Urtasun, Toronto (CA)

(21) Appl. No.: 16/133,046

(22) Filed: Sep. 17, 2018

Related U.S. Application Data
(60) Provisional application No. 62/586,631, filed on Nov. 15, 2017.

(51) Int. Cl. G01B 21/20

(52) U.S. Cl. CPC G01B 21/20; G01S 17/42

(57) ABSTRACT

Systems, methods, tangible non-transitory computer-readable media, and devices for object detection are provided. For example, sensor data associated with objects can be received. Segments encompassing areas associated with the objects can be generated based on the sensor data and a machine-learned model. A position, a shape, and an orientation of each of the objects in each of the one or more segments can be determined over a plurality of time intervals. Further, a predicted position, a predicted shape, and a predicted orientation of each of the objects at a last one of the plurality of time intervals can be determined. Furthermore, an output based at least in part on the predicted position, the predicted shape, or the predicted orientation of each of the one or more objects at the last one of the plurality of time intervals can be generated.

### RELATED APPLICATION

The present application is based on and claims benefit of U.S. Provisional Patent Application No. 62/586,631 having a filing date of Nov. 15, 2017, which is incorporated by reference herein.

### FIELD

The present disclosure relates generally to operation of computing systems including the detection of objects through use of machine-learned classifiers.

### BACKGROUND

Various computing systems including autonomous vehicles, robotic systems, and personal computing devices can receive sensor data that is used to determine the state of an environment surrounding the computing systems (e.g., the environment through which an autonomous vehicle travels). However, the environment surrounding the computing system is subject to change over time. Additionally, the environment surrounding the computing system can include a complex combination of static and moving objects. As such, the efficient operation of various computing systems (e.g., computing systems of an autonomous vehicle) depends on the detection of these objects.

However, existing ways of detecting objects can be lacking in terms of the rapidity, precision, or accuracy of detection. Accordingly, there exists a need for a computing system (e.g., an autonomous vehicle, a robotic system, or a personal computing device) that is able to more effectively detect objects (e.g., objects proximate to an autonomous vehicle).

### SUMMARY

Aspects and advantages of embodiments of the present disclosure will be set forth in part in the following description, or may be learned from the description, or may be learned through practice of the embodiments

An example aspect of the present disclosure is directed to a computer-implemented method of object detection. The computer-implemented method of object detection can include receiving, by a computing system including one or more computing devices, sensor data that can include information based at least in part on sensor output associated with one or more three-dimensional representations including one or more objects detected by one or more sensors. Each of the one or more three-dimensional representations can include a plurality of points . . . . The computer-implemented method can include generating, by the computing system, based at least in part on the sensor data and a machine-learned model, one or more one or more segments of the one or more three-dimensional representations. Each of the one or more segments can include a set of the plurality of points associated with at least one of the one or more objects. The computer-implemented method can include determining, by the computing system, a position, a shape, and an orientation of each of the one or more objects in each of the one or more segments over a plurality of time intervals. The computer-implemented method can include determining, by the computing system, based at least in part on the machine-learned model and the position, the shape, and the orientation of each of the one or more objects, a predicted position, a predicted shape, and a predicted orientation of each of the one or more objects at a last one of the plurality of time intervals. The computer-implemented method can include generating, by the computing system, an output based at least in part on the predicted position, the predicted shape, or the predicted orientation of each of the one or more objects at the last one of the plurality of time intervals. Furthermore, the output can include one or more indications associated with detection of the one or more objects.

Another example aspect of the present disclosure is directed to an object detection system. The objects detection can include one or more processors; a machine-learned object detection model trained to receive sensor data and, responsive to receiving the sensor data, generate output including one or more detected object predictions; and a memory that can include one or more computer-readable media, the memory storing computer-readable instructions that when executed by the one or more processors cause the one or more processors to perform operations. The operations can include receiving sensor data from one or more sensors. The sensor data can include information associated with a set of physical dimensions of one or more objects. The operations can include sending the sensor data to the machine-learned object detection model. Further, the operations can include generating, based at least in part on output from the machine-learned object detection model, one or more detected object predictions including one or more positions, one or more shapes, or one or more orientations of the one or more objects.

Another example aspect of the present disclosure is directed to a computing device. The computing device can include one or more processors and a memory including one or more computer-readable media. The memory can store computer-readable instructions that when executed by the one or more processors cause the one or more processors to perform operations. The operations can include receiving sensor data that can include information based at least in part on sensor output associated with one or more three-dimensional representations including one or more objects detected by one or more sensors. Each of the one or more three-dimensional representations can include a plurality of points. The operations can include generating, based at least in part on the sensor data and a machine-learned model, one or more segments of the one or more three-dimensional representations. Each of the one or more segments can include a set of the plurality of points associated with at least one of the one or more objects. The operations can include determining a position, a shape, and an orientation of each of the one or more objects in each of the one or more segments over a plurality of time intervals. Further, the operations can include determining, based at least in part on the machine-learned model and the position, the shape, and the orientation of each of the one or more objects, a predicted position, a predicted shape, and a predicted orientation of each of the one or more objects at a last one of the plurality of time intervals. The operations can include generating an output based at least in part on the predicted position, the predicted shape, or the predicted orientation of each of the one or more objects at the last one of the plurality of time intervals. The output can include one or more indications associated with detection of the one or more objects.

Other example aspects of the present disclosure are directed to other systems, methods, vehicles, apparatuses, tangible non-transitory computer-readable media, and devices for object detection including the determination of a position, shape, and/or orientation of objects detectable by sensors of a computing system including an autonomous vehicle, robotic system, and/or a personal computing device.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a diagram of an example system according to example embodiments of the present disclosure;

FIG. 2 depicts an example of determining the position, shape, and orientation of one or more objects in an environment using a joint segmentation and detection technique according to example embodiments of the present disclosure;

FIG. 3 depicts an example of determining the position, shape, and orientation of one or more objects in an environment using a joint segmentation and detection technique according to example embodiments of the present disclosure;

FIG. 4 depicts an example of a three-dimensional object detection system according to example embodiments of the present disclosure;

FIG. 5 depicts an example of a network architecture for a machine-learned model according to example embodiments of the present disclosure;

FIG. 6 depicts an example of geometry output parametrization for a sample according to example embodiments of the present disclosure;

FIG. 7 depicts a flow diagram of an example method of determining the position, shape, and orientation of one or more objects in an environment using a joint segmentation and detection technique according to example embodiments of the present disclosure;

FIG. 8 depicts a flow diagram of an example method of determining the position, shape, and orientation of one or more objects in an environment using a joint segmentation and detection technique according to example embodiments of the present disclosure;

FIG. 9 depicts a flow diagram of an example method of training a machine-learned model according to example embodiments of the present disclosure;

FIG. 10 depicts a flow diagram of an example method of determining the position, shape, and orientation of one or more objects in an environment using a joint segmentation and detection technique according to example embodiments of the present disclosure;

FIG. 11 depicts a flow diagram of an example method of determining the position, shape, and orientation of one or more objects in an environment using a joint segmentation and detection technique according to example embodiments of the present disclosure; and

FIG. 12 depicts a diagram of an example system including a machine learning computing system according to example embodiments of the present disclosure.

### DETAILED DESCRIPTION

Example aspects of the present disclosure are directed at detecting, recognizing, and/or predicting the movement of one or more objects (e.g., vehicles, pedestrians, and/or cyclists) in an environment proximate (e.g., within a predetermined distance) to a computing system including a vehicle (e.g., an autonomous vehicle, a semi-autonomous vehicle, or a manually operated vehicle), a robotic system, and/or a personal computing device, through use of sensor output (e.g., one or more light detection and ranging (LIDAR) device outputs, sonar outputs, radar outputs, and/or camera outputs) and a machine-learned model. More particularly, aspects of the present disclosure include determining a set of positions, shapes, and orientations of one or more objects (e.g., physical locations, physical dimensions, headings, directions, and/or bearings) and a set of predicted positions, predicted shapes, and predicted orientations (e.g., one or more predicted physical locations, predicted physical dimensions, and predicted headings, directions, and/or bearings of the one or more objects at a future time) of one or more objects associated with sensor output (e.g., a vehicle's sensor outputs based on detection of objects within range of the vehicle's sensors) sensor outputs based at least in part on detection of the one or more objects, including portions of the one or more objects that are not detected by the sensors (e.g., map data that provides information about the physical disposition of areas not detected by the sensors).

The computing system can receive data including sensor data associated with one or more states including one or more positions (e.g., geographical locations), shapes (e.g., one or more physical dimensions including length, width, and/or height), and/or orientations (e.g., one or more compass orientations) of one or more objects. Based at least in part on the sensor data and through use of a machine-learned model (e.g., a model trained to detect and/or classify one or more objects), the vehicle can determine properties and/or attributes of the one or more objects including one or more positions, shapes, and/or orientations of the one or more objects. In some embodiments, a computing system can more effectively detect the one or more objects through determination of one or more segments associated with the one or more objects.

As such, the disclosed technology can better determine and predict the position, shape, and orientation of objects in proximity to a vehicle. In particular, by enabling more effective determination of current and predicted object positions, shapes, and/or orientations, the disclosed technology allows for safer vehicle operation through more rapid, precise, and accurate object detection that more efficiently utilizes computing resources.

By way of example, the vehicle can receive sensor data from one or more sensors on the vehicle (e.g., one or more LIDAR devices, image sensors, microphones, radar devices, thermal imaging devices, and/or sonar.) In some embodiments, the sensor data can include LIDAR data associated with the three-dimensional positions or locations of objects detected by a LIDAR system (e.g., LIDAR point cloud data).

The vehicle can also access (e.g., access local data or retrieve data from a remote source) a machine-learned model that is based on classified features associated with classified training objects (e.g., training sets of pedestrians, trucks, automobiles, and/or cyclists, that have had their features extracted, and have been classified by the machine-learned model). The vehicle can use any combination of the sensor data and/or the machine-learned model to determine positions, shapes, and/or orientations of the objects (e.g., the positions, shapes, and/or orientations of pedestrians and vehicles within a predetermined range of the vehicle).

The vehicle can include one or more systems including an object detection computing system (e.g., a computing system including one or more computing devices with one or more processors and a memory) and/or a vehicle control system that can control a variety of vehicle systems and vehicle components. The object detection computing system can process, generate, and/or exchange (e.g., send or receive) signals or data, including signals or data exchanged with various vehicle systems, vehicle components, other vehicles, or remote computing systems.

For example, the object detection computing system can exchange signals (e.g., electronic signals) or data with vehicle systems including sensor systems (e.g., sensors that generate output based on the state of the physical environment external to the vehicle, including LIDAR, cameras, microphones, radar, or sonar); communication systems (e.g., wired or wireless communication systems that can exchange signals or data with other devices); navigation systems (e.g., devices that can receive signals from GPS, GLONASS, or other systems used to determine a vehicle's geographical location); notification systems (e.g., devices used to provide notifications to pedestrians and/or other vehicles, including display devices, status indicator lights, or audio output systems); braking systems used to decelerate the vehicle (e.g., brakes of the vehicle including mechanical and/or electric brakes); propulsion systems used to move the vehicle from one location to another (e.g., motors or engines including electric engines and/or internal combustion engines); and/or steering systems used to change the path, course, or direction of travel of the vehicle.

The object detection computing system can access a machine-learned model that has been generated and/or trained in part using training data including a plurality of classified features and a plurality of classified object labels. In some embodiments, the plurality of classified features can be extracted from point cloud data that includes a plurality of three-dimensional points associated with sensor output including output from one or more sensors (e.g., one or more LIDAR devices and/or cameras).

When the machine-learned model has been trained, the machine-learned model can associate the plurality of classified features with one or more classified object labels that are used to classify or categorize objects including objects that are not included in the plurality of training objects. In some embodiments, as part of the process of training the machine-learned model, the differences in correct classification output between a machine-learned model (that outputs the one or more classified object labels) and a set of classified object labels associated with a plurality of training objects that have previously been correctly identified (e.g., ground truth labels), can be processed using an error loss function that can determine a set of probability distributions based on repeated classification of the same plurality of training objects. As such, the effectiveness (e.g., the rate of correct identification of objects) of the machine-learned model can be improved over time.

The object detection computing system can access the machine-learned model in various ways including exchanging (sending and/or receiving via a network) data or information associated with a machine-learned model that is stored on a remote computing device; and/or accessing a machine-learned model that is stored locally (e.g., in one or more storage devices of the vehicle).

The plurality of classified features can be associated with one or more values that can be analyzed individually and/or in various aggregations. The analysis of the one or more values associated with the plurality of classified features can include determining a mean, mode, median, variance, standard deviation, maximum, minimum, and/or frequency of the one or more values associated with the plurality of classified features. Further, the analysis of the one or more values associated with the plurality of classified features can include comparisons of the differences or similarities between the one or more values. For example, the one or more objects associated with an eighteen wheel cargo truck can be associated with a range of positions, shapes, and orientations that are different from the range of positions, shapes, and orientations associated with a compact automobile.

In some embodiments, the plurality of classified features can include a range of velocities associated with the plurality of training objects, a range of shapes associated with the plurality of training objects, a length of the plurality of training objects, a width of the plurality of training objects, and/or a height of the plurality of training objects. The plurality of classified features can be based at least in part on the output from one or more sensors that have captured a plurality of training objects (e.g., actual objects used to train the machine-learned model) from various angles and/or distances in different environments (e.g., urban areas, suburban areas, rural areas, heavy traffic, and/or light traffic) and/or environmental conditions (e.g., bright daylight, rainy days, darkness, snow covered roads, inside parking garages, in tunnels, and/or under streetlights). The one or more classified object labels, which can be used to classify or categorize the one or more objects, can include buildings, roads, city streets, highways, sidewalks, bridges, overpasses, waterways, pedestrians, automobiles, trucks, and/or cyclists.

In some embodiments, the classifier data can be based at least in part on a plurality of classified features extracted from sensor data associated with output from one or more sensors associated with a plurality of training objects (e.g., previously classified pedestrians, automobiles, trucks, and/or cyclists). The sensors used to obtain sensor data from which features can be extracted can include one or more LIDAR devices, one or more radar devices, one or more sonar devices, and/or one or more image sensors.

The machine-learned model can be generated based at least in part on one or more classification processes or classification techniques. The one or more classification processes or classification techniques can include one or more computing processes performed by one or more computing devices based at least in part on sensor data associated with physical outputs from a sensor device. The one or more computing processes can include the classification (e.g., allocation or sorting into different groups or categories) of the physical outputs from the sensor device, based at least in part on one or more classification criteria (e.g., a position, shape, orientation, size, velocity, and/or acceleration associated with an object).

The machine-learned model can compare the sensor data to the classifier data based at least in part on sensor outputs captured from the detection of one or more classified objects (e.g., thousands or millions of objects) in various environments or conditions. Based on the comparison, the object detection computing system can determine one or more properties and/or attributes of the one or more objects. The one or more properties and/or attributes can be mapped to, or associated with, one or more object classes based at least in part on one or more classification criteria.

For example, one or more classification criteria can distinguish an automobile class from a truck class based at least in part on their respective sets of features. The automobile class can be associated with one set of shape features (e.g., a low smooth profile) and size features (e.g., a size range of ten cubic meters to thirty cubic meters) and a truck class can be associated with a different set of shape features (e.g., a more rectangular profile) and size features (e.g., a size range of fifty to two hundred cubic meters).

Further, the velocity and/or acceleration of detected objects can be associated with different object classes (e.g., pedestrian velocity can be lower than six kilometers per hour and a vehicle's velocity can be greater than one-hundred kilometers per hour).

In some embodiments, an object detection system can include: one or more processors; a machine-learned object detection model trained to receive sensor data and, responsive to receiving the sensor data, generate output comprising one or more detected object predictions; and a memory comprising one or more computer-readable media, the memory storing computer-readable instructions that when executed by the one or more processors cause the one or more processors to perform operations. The operations performed by the object detection system can include receiving sensor data from one or more sensors (e.g., one or more sensors associated with an autonomous vehicle). The sensor data can include information associated with a set of physical dimensions of one or more objects.

The sensor data can be sent to the machine-learned object detection model which can process the sensor data and generate an output (e.g., classification of the sensor outputs). Further, the object detection system can generate, based at least in part on output from the machine-learned object detection model, one or more detected object predictions that include one or more positions, one or more shapes, and/or one or more orientations of the one or more objects.

In some embodiments, the object detection system can generate detection output that is based at least in part on the one or more detected object predictions. The detection output can include one or more indications associated with the one or more positions, the one or more shapes, or the one or more orientations of the one or more objects over a plurality of time intervals. For example, the output can be displayed on a display output device in the form of a graphic representation of the positions, shapes, and/or orientations of the one or more objects.

The object detection computing system can receive sensor data comprising information based at least in part on sensor output associated with one or more areas comprising one or more objects detected by one or more sensors (e.g., one or more sensors of an autonomous vehicle). In some embodiments, the one or more areas can be associated with one or more multi-dimensional representations that include a plurality of points (e.g., a plurality of points from a LIDAR point cloud and/or a plurality of points associated with an image that includes a plurality of pixels).

The one or more objects can include one or more objects external to the vehicle including one or more pedestrians (e.g., one or more persons standing, sitting, walking, or running) and/or implements carried or in contact with the one or more pedestrians (e.g., an umbrella, a cane, a cart, and/or a stroller), one or more other vehicles (e.g., automobiles, trucks, buses, trolleys, motorcycles, airplanes, helicopters, boats, amphibious vehicles, and/or trains), one or more cyclists (e.g., persons sitting or riding on bicycles).

Further, the sensor data can be based at least in part on sensor output associated with one or more physical properties or attributes of the one or more objects. The one or more sensor outputs can be associated with the position, shape, orientation, texture, velocity, acceleration, and/or physical dimensions (e.g., length, width, and/or height) of the one or more objects or portions of the one or more objects (e.g., a side of the one or more objects that is facing away from, or parallel to, the vehicle).

In some embodiments, the sensor data can include a set of three-dimensional points (e.g., x, y, and z coordinates) associated with one or more physical dimensions (e.g., the length, width, and/or height) of the one or more objects, one or more locations (e.g., physical locations) of the one or more objects, and/or one or more relative locations of the one or more objects relative to a point of reference (e.g., the location of an object relative to a portion of an autonomous vehicle). In some embodiments, the sensor data can be based at least in part on outputs from a variety of devices or systems including vehicle systems (e.g., sensor systems of the vehicle) or systems external to the vehicle including remote sensor systems (e.g., sensor systems on traffic lights, roads, or sensor systems on other vehicles).

In some embodiments, the object detection computing system can generate, based at least in part on the sensor data and a machine-learned model, one or more segments of the one or more representations (e.g., three-dimensional representations), wherein each of the one or more segments comprises a set of the plurality of points associated with one of the one or more objects. For example, the one or more segments can be based at least in part on pixel-wise dense predictions of the position, shape, and orientation of the one or more objects.

The object detection computing system can receive map data associated with the one or more areas. The map data can include information associated with one or more background portions of the one or more areas that do not include the one or more objects. In some embodiments, the one or more segments do not include the one or more background portions of the one or more areas (e.g., the one or more background portions are excluded from the one or more segments).

In some embodiments, the object detection computing system can determine, based at least in part on the map data, portions of the one or more representations that are associated with a region of interest mask that includes a set of the plurality of points not associated with the one or more objects. For example, the one or more representations associated with the region of interest mask can be excluded from the one or more segments.

The object detection computing system can receive one or more sensor outputs from one or more sensors (e.g., one or more sensors of an autonomous vehicle, a robotic system, or a personal computing device). The sensor output(s) can include a plurality of three-dimensional points associated with surfaces of the one or more objects detected in the sensor data (e.g., the x, y, and z coordinates associated with the surface of an object based at least in part on one or more reflected laser pulses from a LIDAR device of the vehicle). The one or more sensors can detect the state (e.g., physical properties and/or attributes) of the environment or one or more objects external to the vehicle and can include one or more LIDAR devices, one or more radar devices, one or more sonar devices, one or more thermal sensors, or one or more image sensors.

In some embodiments, the object detection computing system can determine a position, a shape, and an orientation of each of the at least one of the one or more objects in each of the one or more segments over a plurality of time intervals. For example, when the object detection computing system generates one or more segments, each of which includes a set of the plurality of points associated with one or more representations associated with the sensor output, the object detection computing system can use the position, shape, and orientation of each segment to determine or estimate the position, shape, and/or orientation of the associated object.

In some embodiments, based on the one or more properties and/or attributes, the object detection computing system can classify the sensor data based at least in part on the extent to which the newly received sensor data corresponds to the features associated with the one or more object classes. In some embodiments, the one or more classification processes or classification techniques can be based at least in part on a neural network (e.g., deep neural network, convolutional neural network), gradient boosting, a support vector machine, a logistic regression classifier, a decision tree, ensemble model, Bayesian network, k-nearest neighbor model (KNN), and/or other type of model including linear models and/or non-linear models.

The object detection computing system can determine, based at least in part on the machine-learned model and the position, the shape, and the orientation of each of the one or more objects, a predicted position, a predicted shape, and/or a predicted orientation of each of the one or more objects at a last one of the plurality of time intervals (e.g., at a time immediately after the position, shape, and/or orientation of the one or more objects has been determined). For example, the object detection computing system can determine the position, shape, and orientation of an object at time intervals from half a second in the past to half a second into the future.

The object detection computing system can generate an output based at least in part on the predicted position, the predicted shape, and/or the predicted orientation of each of the one or more objects at the last one of the plurality of time intervals (e.g., at a time after the position, shape, and/or orientation of the one or more objects has been determined). The output can include one or more indications associated with detection of the one or more objects (e.g., outputs to a display output device indicating the position, shape, and orientation of the one or more objects).

In some embodiments, the object detection computing system can determine, for each of the one or more objects, one or more differences between the position and the predicted position, the shape and the predicted shape, or the orientation and the predicted orientation. For example, the object detection computing system can compare various properties or attributes of the one or more objects at a present time to the one or more properties or attributes that were predicted.

Further, the object detection computing system can determine, for each of the one or more objects, based at least in part on the differences between the position and the predicted position, the shape and the predicted shape, and/or the orientation and the predicted orientation, a position offset, a shape offset, and an orientation offset respectively. A subsequent predicted position, a subsequent predicted shape, and a subsequent predicted orientation of the one or more objects in a time subsequent to the plurality of time intervals can be based at least in part on the position offset, the shape offset, and the orientation offset. For example, a greater position offset can result in a greater adjustment in the predicted position of an object, whereas a position offset of zero can result in no adjustment in the predicted position of the object.

In some embodiments, responsive to the position offset exceeding a position threshold, the shape offset exceeding a shape threshold, and/or the orientation exceeding an orientation threshold, the object detection computing system can increase a duration of the subsequent plurality of time intervals used to determine the subsequent predicted position, the subsequent predicted shape, or the subsequent predicted orientation respectively. For example, when the magnitude of the position offset is large, the object detection computing system can increase the plurality of time intervals used in determining the position of the one or more objects from one second to two seconds of sensor output associated with the position of the one or more objects. In this way, the object detection computing system can achieve more accurate predictions through use of a larger dataset.

In some embodiments, the object detection computing system can determine, based at least in part on the relative position of the plurality of points, a center point associated with each of the one or more segments. In some embodiments, determining the position, the shape, and/or the orientation of each of the one or more objects is based at least in part on the center point associated with each of the one or more segments. For example, the object detection computing system can use one or more edge detection techniques to detect edges of the one or more segments and can determine a center point of a segment based on the distance between the detected edges. Accordingly, the center point of the segment can be used to predict a center point of an object within the segment.

In some embodiments, the object detection computing system can determine, based at least in part on the sensor data and the machine-learned model, the one or more segments that overlap. Further, the object detection computing system can determine, based at least in part on the shape, the position, and/or the orientation of each of the one or more objects in the one or more segments, one or more boundaries between each of the one or more segments that overlap. The shape, the position, and/or the orientation of each of the one or more objects can be based at least in part on the one or more boundaries between each of the one or more segments. For example, two vehicles that are close together can appear to be one object, however, if the two vehicles are perpendicular to one another (e.g., forming an “L” shape), the object detection computing system can determine that based on the shape of the segment (e.g., the “L” shape) that the segment is actually composed of two objects and that the boundary between the two objects is at the intersection where the two vehicles are close together or touching.

In some embodiments, each of the plurality of points can be associated with a set of dimensions including a vertical dimension (e.g., a dimension associated with a height of an object), a longitudinal dimension (e.g., a dimension associated with a width of an object), and a latitudinal dimension (e.g., a dimension associated with a length of an object). Further, in some embodiments the set of dimensions can include three dimensions including three dimensions associated with an x axis, a y axis, and a z axis respectively. In this way, the plurality of points can be used as a three-dimensional representation of the one or more objects in the one or more representations.

In some embodiments, determining the one or more segments can be based at least in part on a thresholding technique comprising comparison of one or more attributes of each of the plurality of points to one or more threshold pixel attributes comprising luminance or chrominance. For example, a luminance threshold (e.g., a brightness level associated with a point) can be used to determine the one or more segments by masking the points that exceed or do not exceed the luminance threshold.

In some embodiments, the object detection computing system can determine, based at least in part on the position, the shape, and/or the orientation of the one or more objects in the one or more segments that overlap, the occurrence of one or more duplicates among the one or more segments. In some embodiments, the one or more duplicates can be excluded from the one or more segments by using a filtering technique such as, for example, non-maximum suppression. In this way, the disclosed technology can reduce the number of false positive detections of objects.

The systems, methods, and devices in the disclosed technology can provide a variety of technical effects and benefits to the overall operation of the vehicle and the determination of properties or attributes of objects including the positions, shapes, and/or orientations of objects proximate to the vehicle. The disclosed technology can more effectively determine the properties and/or attributes of objects through use of a machine-learned model that facilitates rapid and accurate detection and/or recognition of objects. Further, use of a machine-learned model enables objects to be more effectively detected and/or recognized in comparison with other approaches including rules-based determination systems.

Example systems in accordance with the disclosed technology can achieve significantly improved average orientation error and a reduction in the number of position outliers (e.g., the number of times in which the difference between predicted position and actual position exceeds a position threshold value), shape outliers (e.g., the number of times in which the difference between predicted shape and actual shape exceeds a shape threshold value), and/or orientation outliers (e.g., the number of times in which the difference between predicted orientation and actual orientation is greater than some threshold value). Furthermore, the machine-learned model can be more readily adjusted (e.g., via retraining on a new or modified set of training data) than a rules-based system (e.g., via arduous, manual re-writing a set of rules) as the object detection computing system can be periodically updated to be able to better calculate the nuances of object properties and/or attributes (e.g., position, shape, and/or orientation). This can allow for more efficient upgrading of the object detection computing system and a reduction in vehicle downtime.

The systems, methods, and devices in the disclosed technology have an additional technical effect and benefit of improved scalability by using a machine-learned model to determine object properties and/or attributes including position, shape, and/or orientation. In particular, modeling object properties and/or attributes through machine-learned models greatly reduces the research time needed relative to development of hand-crafted object position, shape, and/or orientation determination rules.

For example, for manually created (e.g., rules conceived and written by one or more people) object detection rules, a designer may need to derive heuristic models of how different objects may exhibit different properties and/or attributes in different scenarios. It can be difficult to manually create rules that effectively address all possible scenarios that an autonomous vehicle, a robotic system, and/or a personal device may encounter relative to other detected objects. By contrast, the disclosed technology, through use of machine-learned models, can train a model on training data, which can be done at a scale proportional to the available resources of the training system (e.g., a massive scale of training data can be used to train the machine-learned model). Further, the machine-learned models can easily be revised as new training data is made available. As such, use of a machine-learned model trained on labeled sensor data can provide a scalable and customizable solution.

As such, the superior determinations of object properties and/or attributes (e.g., positions, shapes, and/or orientations) permit improved safety for passengers of the vehicle and to pedestrians and other vehicles. Further, the disclosed technology can achieve improved fuel economy by requiring fewer course corrections and other sub-optimal maneuvers resulting from inaccurate object detection. Additionally, the disclosed technology can result in more efficient utilization of computational resources due to the improvements in processing sensor outputs that come from implementing the disclosed segmentation and detection techniques.

The disclosed technology can also improve the operation of a vehicle by reducing the amount of wear and tear on vehicle components through more gradual adjustments in the vehicle's travel path that can be performed based on the improved orientation information associated with the position, shape, and/or orientation of objects in the vehicle's environment. For example, earlier and more accurate and precise determination of the positions, shapes, and/or orientations of objects can result in a smoother ride since the current and predicted position, shape, and/or orientation of objects can be more accurately predicted, thereby allowing for smoother vehicle guidance that reduces the amount of strain on the vehicle's engine, braking, and steering systems.

Accordingly, the disclosed technology provides more accurate detection and determination of object positions, shapes, and/or orientations along with operational benefits including enhanced vehicle safety through predictive object tracking, as well as a reduction in wear and tear on device components (e.g., vehicle components and/or robotic system components) through smoother device (e.g., vehicle or robot) navigation based on more effective determination of object positions, shapes, and orientations.

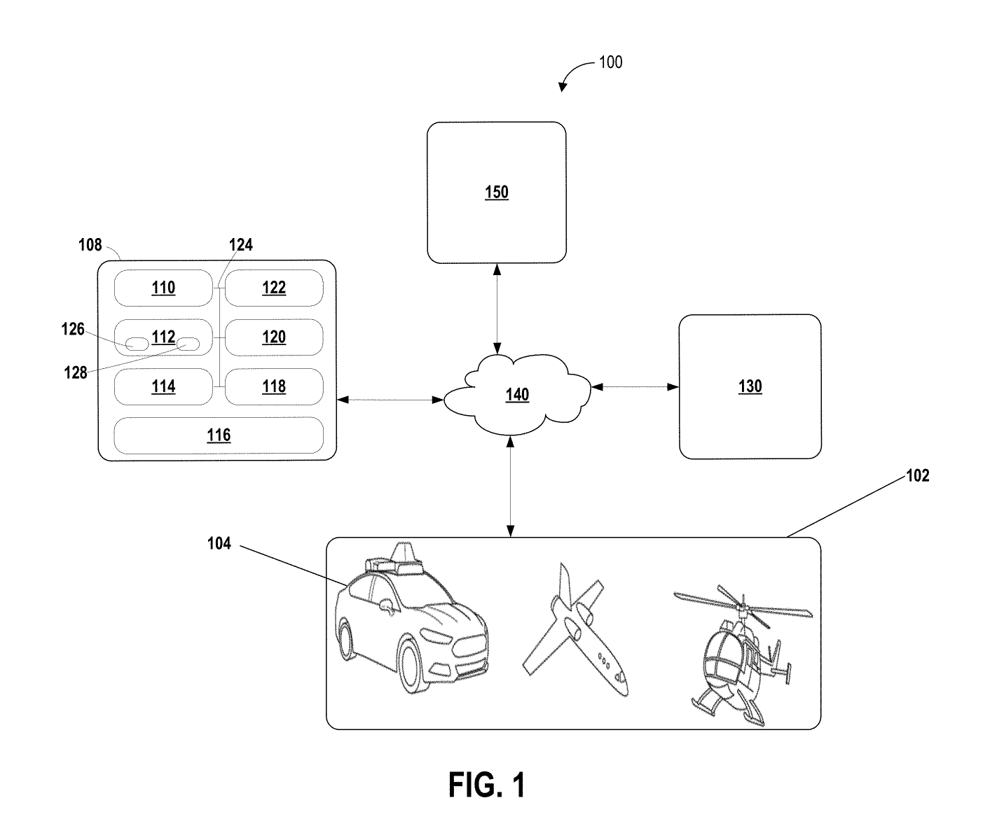

With reference now to FIGS. 1-12, example embodiments of the present disclosure will be discussed in further detail. FIG. 1 depicts a diagram of an example system 100 according to example embodiments of the present disclosure. The system 100 can include a plurality of vehicles 102; a vehicle 104; a computing system 108 that includes one or more computing devices 110; one or more data acquisition systems 112; an autonomy system 114; one or more control systems 116; one or more human machine interface systems 118; other vehicle systems 120; a communications system 122; a network 124; one or more image capture devices 126; one or more sensors 128; one or more remote computing devices 130; a communication network 140; and an operations computing system 150.

The operations computing system 150 can be associated with a service provider that provides one or more vehicle services to a plurality of users via a fleet of vehicles that includes, for example, the vehicle 104. The vehicle services can include transportation services (e.g., rideshare services), courier services, delivery services, and/or other types of services.

The operations computing system 150 can include multiple components for performing various operations and functions. For example, the operations computing system 150 can include and/or otherwise be associated with one or more remote computing devices that are remote from the vehicle 104. The one or more remote computing devices can include one or more processors and one or more memory devices. The one or more memory devices can store instructions that when executed by the one or more processors cause the one or more processors to perform operations and functions associated with operation of the vehicle including receiving sensor data; generating one or more segments; determining a position, shape, and/or orientation of one or more objects, determining a predicted position, predicted shape, and/or predicted orientation of one or more objects; and generating an output which can include one or more indications.

For example, the operations computing system 150 can be configured to monitor and communicate with the vehicle 104 and/or its users to coordinate a vehicle service provided by the vehicle 104. To do so, the operations computing system 150 can manage a database that includes data including vehicle status data associated with the status of vehicles including the vehicle 104. The vehicle status data can include a location of the plurality of vehicles 102 (e.g., a latitude and longitude of a vehicle), the availability of a vehicle (e.g., whether a vehicle is available to pick-up or drop-off passengers and/or cargo), or the state of objects external to the vehicle (e.g., the physical dimensions and/or appearance of objects external to the vehicle).

An indication, record, and/or other data indicative of the state of one or more objects, including the physical dimensions and/or appearance of the one or more objects, can be stored locally in one or more memory devices of the vehicle 104. Furthermore, the vehicle 104 can provide data indicative of the state of the one or more objects (e.g., physical dimensions or appearance of the one or more objects) within a predefined distance of the vehicle 104 to the operations computing system 150, which can store an indication, record, and/or other data indicative of the state of the one or more objects within a predefined distance of the vehicle 104 in one or more memory devices associated with the operations computing system 150 (e.g., remote from the vehicle).

The operations computing system 150 can communicate with the vehicle 104 via one or more communications networks including the communications network 140. The communications network 140 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 140 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 104.

The vehicle 104 can be a ground-based vehicle (e.g., an automobile), an aircraft, and/or another type of vehicle. The vehicle 104 can be an autonomous vehicle that can perform various actions including driving, navigating, and/or operating, with minimal and/or no interaction from a human driver. The vehicle 104 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 104 can provide driving and navigational operation with minimal and/or no interaction from a human driver present in the vehicle. A semi-autonomous operational mode can be one in which the vehicle 104 can operate with some interaction from a human driver present in the vehicle. Park and/or sleep modes can be used between operational modes while the vehicle 104 performs various actions including waiting to provide a subsequent vehicle service, and/or recharging between operational modes.

The vehicle 104 can include a computing system 108. The computing system 108 can include various components for performing various operations and functions. For example, the computing system 108 can include one or more computing devices 110 on-board the vehicle 104. The one or more computing devices 110 can include one or more processors and one or more memory devices, each of which are on-board the vehicle 104. The one or more memory devices can store instructions that when executed by the one or more processors cause the one or more processors to perform operations and functions, such as those taking the vehicle 104 out-of-service, stopping the motion of the vehicle 104, determining the state of one or more objects within a predefined distance of the vehicle 104, or generating indications associated with the state of one or more objects within a predefined distance of the vehicle 104, as described in the present disclosure.

The one or more computing devices 110 can implement, include, and/or otherwise be associated with various other systems on-board the vehicle 104. The one or more computing devices 110 can be configured to communicate with these other on-board systems of the vehicle 104. For instance, the one or more computing devices 110 can be configured to communicate with one or more data acquisition systems 112, an autonomy system 114 (e.g., including a navigation system), one or more control systems 116, one or more human machine interface systems 118, other vehicle systems 120, and/or a communications system 122. The one or more computing devices 110 can be configured to communicate with these systems via a network 124. The network 124 can include one or more data buses (e.g., controller area network (CAN)), on-board diagnostics connector (e.g., OBD-II), and/or a combination of wired and/or wireless communication links. The one or more computing devices 110 and/or the other on-board systems can send and/or receive data, messages, and/or signals, amongst one another via the network 124.

The one or more data acquisition systems 112 can include various devices configured to acquire data associated with the vehicle 104. This can include data associated with the vehicle including one or more of the vehicle's systems (e.g., health data), the vehicle's interior, the vehicle's exterior, the vehicle's surroundings, and/or the vehicle users. Further, the one or more data acquisition systems 112 can include, for example, one or more image capture devices 126.

The one or more image capture devices 126 can include one or more cameras, two-dimensional image capture devices, three-dimensional image capture devices, static image capture devices, dynamic (e.g., rotating) image capture devices, video capture devices (e.g., video recorders), lane detectors, scanners, optical readers, electric eyes, and/or other suitable types of image capture devices. The one or more image capture devices 126 can be located in the interior and/or on the exterior of the vehicle 104. The one or more image capture devices 126 can be configured to acquire image data to be used for operation of the vehicle 104 in an autonomous mode. For example, the one or more image capture devices 126 can acquire image data to allow the vehicle 104 to implement one or more machine vision techniques (e.g., to detect objects in the surrounding environment).

Additionally, or alternatively, the one or more data acquisition systems 112 can include one or more sensors 128. The one or more sensors 128 can include impact sensors, motion sensors, pressure sensors, mass sensors, weight sensors, volume sensors (e.g., sensors that can determine the volume of an object in liters), temperature sensors, humidity sensors, LIDAR, RADAR, sonar, radios, medium-range and long-range sensors (e.g., for obtaining information associated with the vehicle's surroundings), global positioning system (GPS) equipment, proximity sensors, and/or any other types of sensors for obtaining data indicative of parameters associated with the vehicle 104 and/or relevant to the operation of the vehicle 104. The one or more data acquisition systems 112 can include the one or more sensors 128 dedicated to obtaining data associated with a particular aspect of the vehicle 104, including, the vehicle's fuel tank, engine, oil compartment, and/or wipers.

The one or more sensors 128 can also, or alternatively, include sensors associated with one or more mechanical and/or electrical components of the vehicle 104. For example, the one or more sensors 128 can be configured to detect whether a vehicle door, trunk, and/or gas cap, is in an open or closed position. In some implementations, the data acquired by the one or more sensors 128 can help detect other vehicles and/or objects, road conditions (e.g., curves, potholes, dips, bumps, and/or changes in grade), measure a distance between the vehicle 104 and other vehicles and/or objects.

The computing system 108 can also be configured to obtain map data and/or path data. For instance, a computing device of the vehicle (e.g., within the autonomy system 114) can be configured to receive map data from one or more remote computing devices including the operations computing system 150 or the one or more remote computing devices 130 (e.g., associated with a geographic mapping service provider). The map data can include any combination of two-dimensional or three-dimensional geographic map data associated with the area in which the vehicle was, is, or will be travelling. The path data can be associated with the map data and include one or more destination locations that the vehicle has traversed or will traverse.

The data acquired from the one or more data acquisition systems 112, the map data, and/or other data can be stored in one or more memory devices on-board the vehicle 104. The on-board memory devices can have limited storage capacity. As such, the data stored in the one or more memory devices may need to be periodically removed, deleted, and/or downloaded to another memory device (e.g., a database of the service provider). The one or more computing devices 110 can be configured to monitor the memory devices, and/or otherwise communicate with an associated processor, to determine how much available data storage is in the one or more memory devices. Further, one or more of the other on-board systems (e.g., the autonomy system 114) can be configured to access the data stored in the one or more memory devices.

The autonomy system 114 can be configured to allow the vehicle 104 to operate in an autonomous mode. For instance, the autonomy system 114 can obtain the data associated with the vehicle 104 (e.g., acquired by the one or more data acquisition systems 112). The autonomy system 114 can also obtain the map data and/or the path data. The autonomy system 114 can control various functions of the vehicle 104 based, at least in part, on the acquired data associated with the vehicle 104 and/or the map data to implement the autonomous mode. For example, the autonomy system 114 can include various models to perceive road features, signage, and/or objects, people, animals, etc. based on the data acquired by the one or more data acquisition systems 112, map data, and/or other data. In some implementations, the autonomy system 114 can include machine-learned models that use the data acquired by the one or more data acquisition systems 112, the map data, and/or other data to help operate the autonomous vehicle. Moreover, the acquired data can help detect other vehicles and/or objects, road conditions (e.g., curves, potholes, dips, bumps, changes in grade, or the like), measure a distance between the vehicle 104 and other vehicles or objects, etc. The autonomy system 114 can be configured to predict the position and/or movement (or lack thereof) of such elements (e.g., using one or more odometry techniques). The autonomy system 114 can be configured to plan the motion of the vehicle 104 based, at least in part, on such predictions. The autonomy system 114 can implement the planned motion to appropriately navigate the vehicle 104 with minimal or no human intervention. For instance, the autonomy system 114 can include a navigation system configured to direct the vehicle 104 to a destination location. The autonomy system 114 can regulate vehicle speed, acceleration, deceleration, steering, and/or operation of other components to operate in an autonomous mode to travel to such a destination location.

The autonomy system 114 can determine a position and/or route for the vehicle 104 in real-time and/or near real-time. For instance, using acquired data, the autonomy system 114 can calculate one or more different potential routes (e.g., every fraction of a second). The autonomy system 114 can then select which route to take and cause the vehicle 104 to navigate accordingly. By way of example, the autonomy system 114 can calculate one or more different straight paths (e.g., including some in different parts of a current lane), one or more lane-change paths, one or more turning paths, and/or one or more stopping paths. The vehicle 104 can select a path based, at last in part, on acquired data, current traffic factors, travelling conditions associated with the vehicle 104, etc. In some implementations, different weights can be applied to different criteria when selecting a path. Once selected, the autonomy system 114 can cause the vehicle 104 to travel according to the selected path.

The one or more control systems 116 of the vehicle 104 can be configured to control one or more aspects of the vehicle 104. For example, the one or more control systems 116 can control one or more access points of the vehicle 104. The one or more access points can include features such as the vehicle's door locks, trunk lock, hood lock, fuel tank access, latches, and/or other mechanical access features that can be adjusted between one or more states, positions, locations, etc. For example, the one or more control systems 116 can be configured to control an access point (e.g., door lock) to adjust the access point between a first state (e.g., lock position) and a second state (e.g., unlocked position). Additionally, or alternatively, the one or more control systems 116 can be configured to control one or more other electrical features of the vehicle 104 that can be adjusted between one or more states. For example, the one or more control systems 116 can be configured to control one or more electrical features (e.g., hazard lights, microphone) to adjust the feature between a first state (e.g., off) and a second state (e.g., on).

The one or more human machine interface systems 118 can be configured to allow interaction between a user (e.g., human), the vehicle 104, the computing system 108, and/or a third party (e.g., an operator associated with the service provider). The one or more human machine interface systems 118 can include a variety of interfaces for the user to input and/or receive information from the computing system 108. For example, the one or more human machine interface systems 118 can include a graphical user interface, direct manipulation interface, web-based user interface, touch user interface, attentive user interface, conversational and/or voice interfaces (e.g., via text messages, chatter robot), conversational interface agent, interactive voice response (IVR) system, gesture interface, and/or other types of interfaces.

Furthermore, the one or more human machine interface systems 118 can include one or more input devices (e.g., one or more touchscreens, keypads, touchpads, knobs, buttons, sliders, switches, mouse input devices, gyroscopes, microphones, and/or other hardware interfaces) configured to receive user input. The one or more human machine interfaces 118 can also include one or more output devices (e.g., one or more display devices, speakers, lights, and/or haptic devices) to receive and/or output data associated with interfaces including the one or more human machine interface systems 118.

The other vehicle systems 120 can be configured to control and/or monitor other aspects of the vehicle 104. For instance, the other vehicle systems 120 can include software update monitors, an engine control unit, transmission control unit, the on-board memory devices, etc. The one or more computing devices 110 can be configured to communicate with the other vehicle systems 120 to receive data and/or to send to one or more signals. By way of example, the software update monitors can provide, to the one or more computing devices 110, data indicative of a current status of the software running on one or more of the on-board systems and/or whether the respective system requires a software update.

The communications system 122 can be configured to allow the computing system 108 (and its one or more computing devices 110) to communicate with other computing devices. In some implementations, the computing system 108 can use the communications system 122 to communicate with one or more user devices over the networks. In some implementations, the communications system 122 can allow the one or more computing devices 110 to communicate with one or more of the systems on-board the vehicle 104. The computing system 108 can use the communications system 122 to communicate with the operations computing system 150 and/or the one or more remote computing devices 130 over the networks (e.g., via one or more wireless signal connections). The communications system 122 can include any suitable components for interfacing with one or more networks, including for example, transmitters, receivers, ports, controllers, antennas, or other suitable components that can help facilitate communication with one or more remote computing devices that are remote from the vehicle 104.

In some implementations, the one or more computing devices 110 on-board the vehicle 104 can obtain vehicle data indicative of one or more parameters associated with the vehicle 104. The one or more parameters can include information, such as health and maintenance information, associated with the vehicle 104, the computing system 108, one or more of the on-board systems, etc. For example, the one or more parameters can include fuel level, engine conditions, tire pressure, conditions associated with the vehicle's interior, conditions associated with the vehicle's exterior, mileage, time until next maintenance, time since last maintenance, available data storage in the on-board memory devices, a charge level of an energy storage device in the vehicle 104, current software status, needed software updates, and/or other heath and maintenance data of the vehicle 104.

At least a portion of the vehicle data indicative of the parameters can be provided via one or more of the systems on-board the vehicle 104. The one or more computing devices 110 can be configured to request the vehicle data from the on-board systems on a scheduled and/or as-needed basis. In some implementations, one or more of the on-board systems can be configured to provide vehicle data indicative of one or more parameters to the one or more computing devices 110 (e.g., periodically, continuously, as-needed, as requested). By way of example, the one or more data acquisitions systems 112 can provide a parameter indicative of the vehicle's fuel level and/or the charge level in a vehicle energy storage device. In some implementations, one or more of the parameters can be indicative of user input. For example, the one or more human machine interfaces 118 can receive user input (e.g., via a user interface displayed on a display device in the vehicle's interior). The one or more human machine interfaces 118 can provide data indicative of the user input to the one or more computing devices 110. In some implementations, the one or more remote computing devices 130 can receive input and can provide data indicative of the user input to the one or more computing devices 110. The one or more computing devices 110 can obtain the data indicative of the user input from the one or more remote computing devices 130 (e.g., via a wireless communication).

The one or more computing devices 110 can be configured to determine the state of the vehicle 104 and the environment around the vehicle 104 including the state of one or more objects external to the vehicle including pedestrians, cyclists, motor vehicles (e.g., trucks, and/or automobiles), roads, waterways, and/or buildings. Further, the determination of the state of the one or more objects can include determining the position (e.g., geographic location), shape (e.g., shape, length, width, and/or height of the one or more objects), and/or orientation (e.g., compass orientation or an orientation relative to the vehicle) of the one or more objects. The one or more computing devices 110 can determine a velocity, a trajectory, and/or a path for vehicle based at least in part on path data that includes a sequence of locations for the vehicle to traverse. Further, the one or more computing devices 110 can receive navigational inputs (e.g., from a steering system of the vehicle 104) to suggest a modification of the vehicle's path, and can activate one or more vehicle systems including steering, propulsion, notification, and/or braking systems.

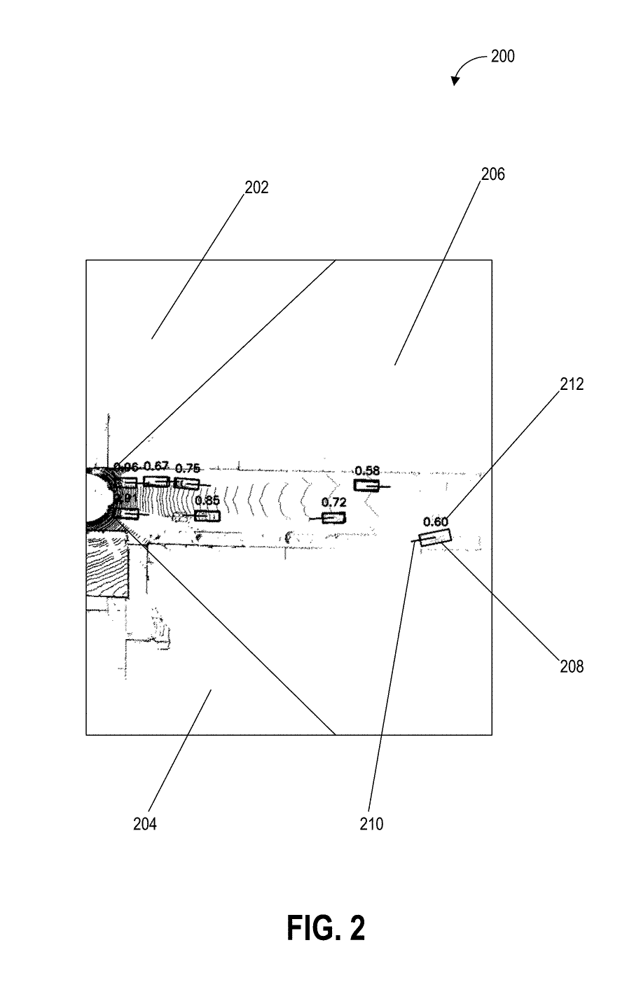

FIG. 2 depicts an example of determining the position, shape, and orientation of one or more objects in an environment using a joint segmentation and detection technique according to example embodiments of the present disclosure. One or more portions of an environment that includes one or more objects can be detected and/or processed by one or more devices (e.g., one or more computing devices) or systems including, for example, the vehicle 104, the computing system 108, and/or the operations computing system 150, shown in FIG. 1. Moreover, the detection and processing of one or more portions of an environment including one or more objects can be implemented as an algorithm on the hardware components of one or more devices or systems (e.g., the vehicle 104, the computing system 108, and/or the operations computing system 150, shown in FIG. 1) to, for example, determine the position, shape, and/or orientation of the one or more objects. As illustrated, FIG. 2 shows an output image 200, a non-detected area 202, a non-detected area 204, a detected area 206, an object 208, an object orientation 210, and a confidence score 212.

The output image 200 includes images generated by a computing system (e.g., the computing system 108) and can include a visual representation of an environment including one or more objects detected by one or more sensors (e.g., one or more image capture devices 126 and/or sensors 128 of the vehicle 104).

As shown, the output image 200 is associated with the output of a computing system (e.g., the computing system 108 that is depicted in FIG. 1). The output image 200 includes the non-detected area 202 and the non-detected area 204 which represent portions of the environment that are not detected by one or more sensor devices (e.g., the one or more sensors 128 of the computing system 108). The output image 200 can also include the detected area 206 which represents a portion of an environment that is detected by one or more sensor devices (e.g., a portion of an environment that is captured by one or more LIDAR devices).

For example, the detected area 206 can include one or more detected objects including the detected object 208 (e.g., a vehicle), for which the object orientation 210 and the confidence score 216 (“0.6”) have been determined. The confidence score 216 can indicate a score for one or more pixels of the detected object 208 that can be used to determine the extent to which a detected object corresponds to a ground-truth object based on, for example, an intersection over union (IoU) of the pixels of the detected object 208 with respect to a ground-truth object.

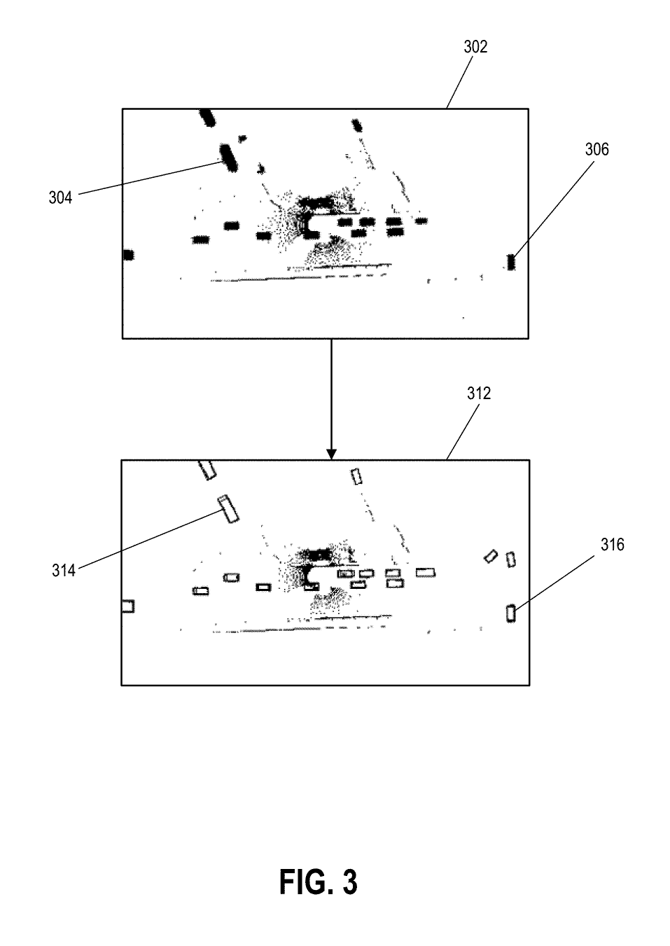

FIG. 3 depicts an example of determining the position, shape, and orientation of one or more objects in an environment using a joint segmentation and detection technique according to example embodiments of the present disclosure. One or more portions of an environment that includes one or more objects can be detected and/or processed by one or more devices (e.g., one or more computing devices) or systems including, for example, the vehicle 104, the computing system 108, and/or the operations computing system 150, shown in FIG. 1. Moreover, the detection and processing of one or more portions of an environment including one or more objects can be implemented as an algorithm on the hardware components of one or more devices or systems (e.g., the vehicle 104, the computing system 108, and/or the operations computing system 150, shown in FIG. 1) to, for example, determine the position, shape, and orientation of the one or more objects. As illustrated, FIG. 3 shows an output image 302, a segment 304, a segment 306, an output image 312, an object 314, and an object 316.

The output image 302 and the output image 312 include images generated by a computing system (e.g., the computing system 108) and can include a visual representation of an environment including one or more objects detected by one or more sensors (e.g., one or more image capture devices 126 and/or sensors 128 of the vehicle 104). As shown, the output image 302 includes multiple segments including the segment 304 and the segment 306. The segment 304 and the segment 306 are associated with one or more objects detected by one or more sensors associated with a computing system (e.g., the computing system 108). The segments including the segment 304 and the segment 306 can be generated based on a convolutional neural network and/or one or more image segmentation techniques including edge detection techniques, thresholding techniques, histogram based techniques, and/or clustering techniques.

The output image 312 includes a visual representation of the same environment represented by the output image 302. As shown, in the output image 312, the object 314 represents a detected object that was within the segment 304 and the object 316 represents a detected object that was within the segment 306. In this example, the segments including the segment 304 and the segment 306 corresponded to the location of detected objects within the environment represented by the output image 302.

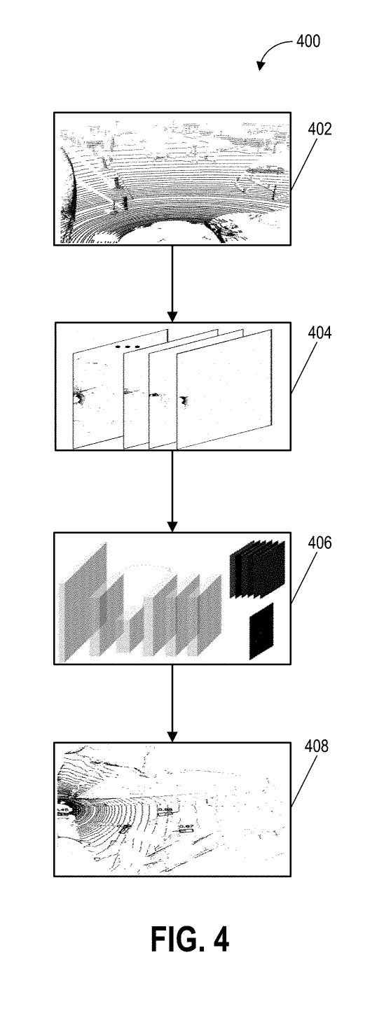

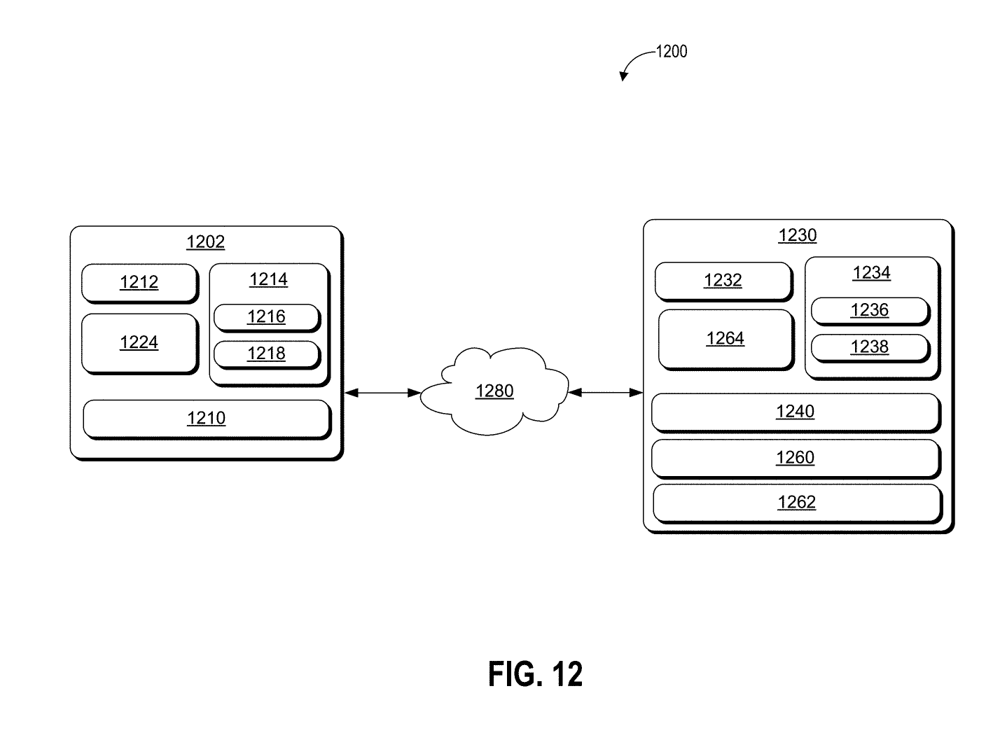

FIG. 4 depicts an example of a three-dimensional object detection system according to example embodiments of the present disclosure. One or more portions of an environment that includes one or more objects can be detected and/or processed by one or more devices (e.g., one or more computing devices) or systems including, for example, the vehicle 104, the computing system 108, and/or the operations computing system 150, shown in FIG. 1. Moreover, the detection and processing of one or more portions of an environment including one or more objects can be implemented as an algorithm on the hardware components of one or more devices or systems (e.g., the vehicle 104, the computing system 108, and/or the operations computing system 150, shown in FIG. 1; and/or the computing system 1202 and/or the machine-learning computing system 1230, shown in FIG. 12) to, for example, determine the position, shape, and orientation of the one or more objects. As illustrated, FIG. 4 shows an object detection system 400, sensor data 402, an input representation 404, a detector 406, and detection output 408.

In this example, an overview of the operation of a three-dimensional object detection system is depicted. For example, the three-dimensional object detection system can receive LIDAR point cloud data from one or more sensors (e.g., one or more autonomous vehicle sensors). As shown, the sensor data 402 (e.g., LIDAR point cloud data) includes a plurality of three-dimensional points associated with one or more objects in an environment (e.g., one or more objects detected by one or more sensors of the vehicle 104).

The input representation 404 shows the transformation of the sensor data 402 into an input representation that is suitable for use by a machine-learned model (e.g., the machine-learned model in the method 700/800/900/1000/1100; the machine-learned model 1210; and/or the machine-learned model 1240).

In some embodiments, the input representation 404 can include a plurality of voxels based at least in part on the sensor data 402. The detector 406 shows a machine-learned model based on a neural network that has multiple layers and has been trained to receive the input representation and output the detection output 408 which can include one or more indications of the position, shape, and/or orientation of the one or more objects associated with the sensor data 402.

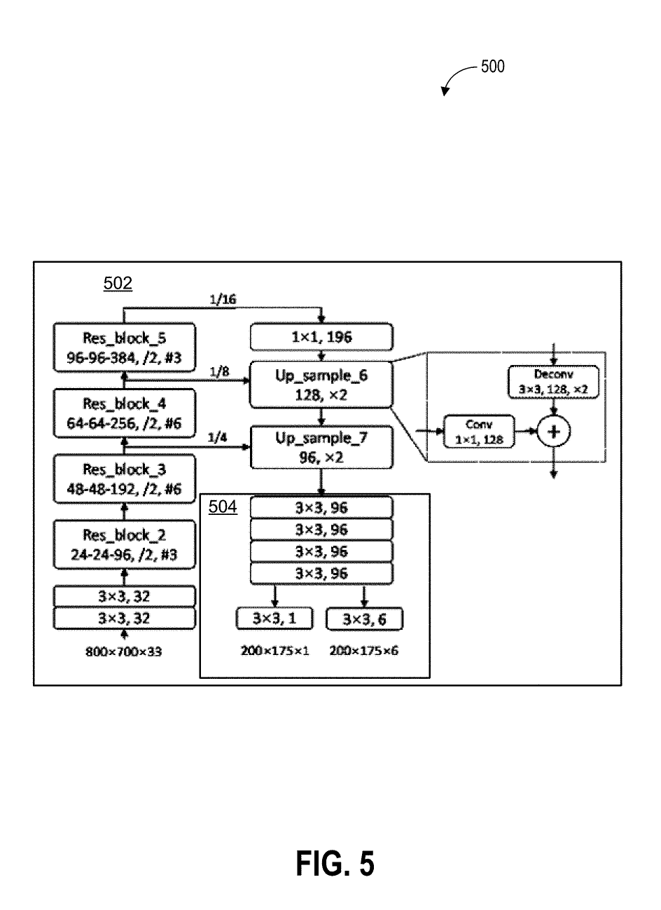

FIG. 5 depicts an example of a neural network architecture according to example embodiments of the present disclosure. The neural network architecture of FIG. 5 can be implemented on one or more devices or systems (e.g., the vehicle 104, the computing system 108, and/or the operations computing system 150, shown in FIG. 1; and/or the computing system 1202 and/or the machine-learning computing system 1230, shown in FIG. 12) to, for example, determine the position, shape, and orientation of the one or more objects. As illustrated, FIG. 5 shows a network 500, a backbone network 502, and a header network 504.

In this example, the network 500 (e.g., a convolutional neural network) can include a single-stage proposal-free network designed for dense non-axis aligned object detection can be used. In some embodiments, a proposal generation branch is not used, instead, dense predictions can be formed, one for each pixel in the input representation (e.g., a two-dimensional input representation for a machine-learned model). Using a fully-convolutional architecture, such dense predictions can be made efficiently. These properties can make the network simple and generalizable with very few hyper-parameters. That is, there can be no need to select anchor priors, define positive and/or negative samples with regard to anchors, and/or tune the hyper-parameters related to the network cascade as in two-stage detectors.

The network architecture can include two parts: the backbone network 502 (e.g., a backbone neural network) and the header network 504 (e.g., a header neural network). The backbone network 502 can be used to extract high-level general feature representation of the input in the form of a convolutional feature map. Further, the backbone network 502 can have high representation capacity to be able to learn robust feature representation. The header network 504 can be used to make task-specific predictions, and can have a single-branch structure with multi-task outputs including a score map from the classification branch and the geometric information of objects from the regression branch. The header network 504 can leverage the advantages of being small and efficient.

With respect to the backbone network 502, convolutional neural networks can include convolutional layers and pooling layers. Convolutional layers can be used to extract over-complete representations of the features output from lower level layers. Pooling layers can be used to down-sample the feature map size to save computation and create more robust feature representations. Convolutional neural networks (CNNs) that are applied to images can, for example, have a down-sampling factor of 16 (16×).

In some embodiments, two additional design changes can be implemented. Firstly, more layers with small channel number in high-resolution can be added to extract more fine-detail information. Secondly, a top-down branch including aspects of a feature pyramid network that combines high-resolution feature maps with low-resolution ones can be adopted so as to up-sample the final feature representation. Further, a residual unit can be used as a building block, which may be simpler to stack and optimize.

The header network 504 can include a multi-task net that does both object recognition and localization. It is designed to be small and efficient. The classification branch can output a one (1) channel feature map followed with sigmoid activation function. The regression branch can output six (6) channel feature maps without non-linearity.

In some embodiments, sharing weights of the two tasks (object recognition and object localization) can lead to improved performance. The classification branch of the header network 504 can output a confidence score with range [0, 1] representing the probability that the pixel belongs to an object. For multi-class object detection, the confidence score can be extended as a vector after soft-max.

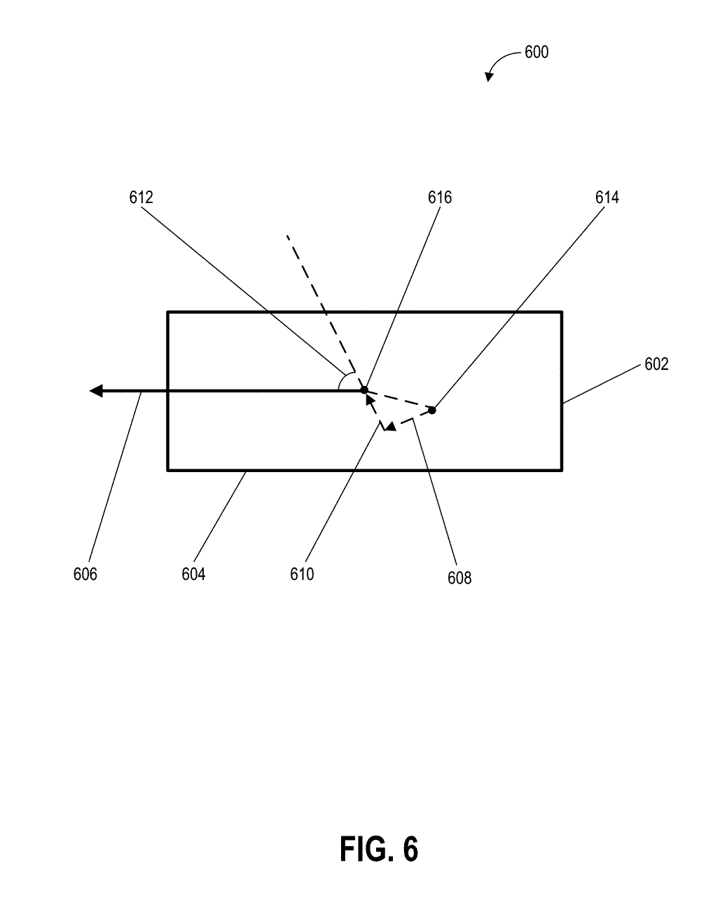

FIG. 6 depicts an example of geometry output parameterization using a neural network according to example embodiments of the present disclosure (e.g., neural network 500 of FIG. 5). As illustrated, FIG. 6 shows a bounding shape 600, a width 602, a length 604, a heading 606, a position offset 608, a position offset 610, a heading angle 612, an object pixel 614, and an object center 616.

In this example, the bounding shape (e.g., a bounding box) can be representative of a bounding shape produced by a neural network (e.g., the header network 504 shown in FIG. 5).

In some embodiments, a non-axis aligned bounding shape 600 can be represented by b which is parameterized as {θ, xc, yc, w, l}, corresponding to the heading angle 612 (θ within range [−π, π]), the object's center position (xc, yc), and the object's size (w, l).

Compared with cuboid based three-dimensional object detection, position and size along the Z axis can be omitted because in some applications (e.g., autonomous driving applications) the objects of interest are constrained to a plane and therefore the goal is to localize the objects on the plane (this setting can be referred to as three-dimensional localization). Given such parameterization, the representation of the regression branch can be cos(θ), sin(θ), dx, dy, w, l for the object pixel 614 at position (px, py).

The heading angle 612, which can be represented αy 0, can be factored into two values to enforce the angle range constraint as the θ as a tan(sin(θ), cos(θ)) is decoded during inference. The position offset 608 and the position offset 610 can be respectively represented as dx and dy, and can correspond to the position offset from the object center 616 to the object pixel 614. The width 602 and the length 604 can be respectively represented as w and l, and can correspond to the size of the object.

In some embodiments, the values for the object position and size can be in real-world metric space. Further, decoding an oriented bounding shape (e.g., the bounding shape 600) at training time and computing regression loss directly on the coordinates of four shape corners (e.g., the four corners of the bounding shape 600) can result in improved performance.

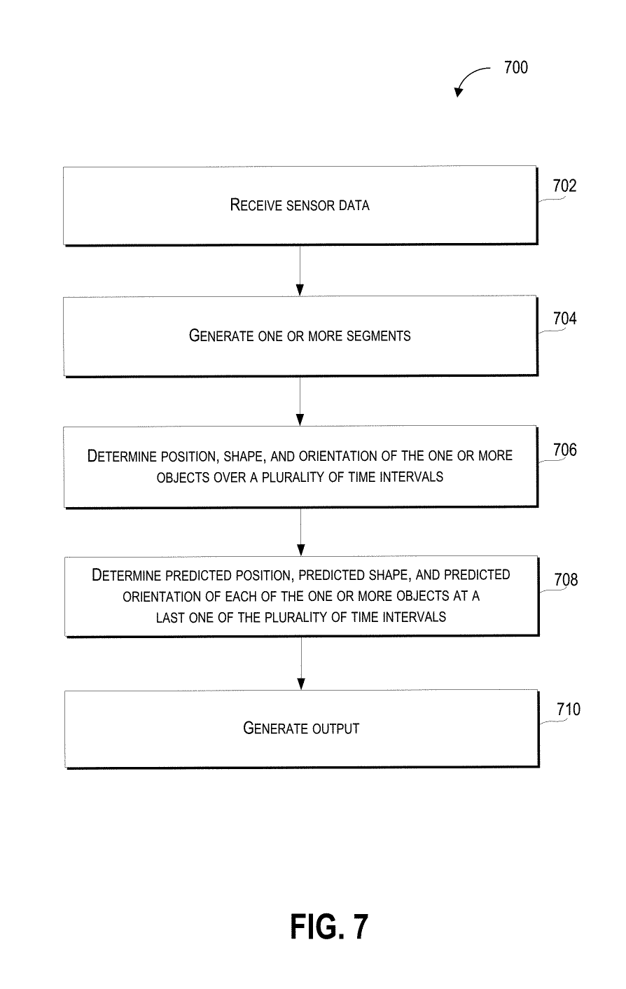

FIG. 7 depicts a flow diagram of an example method of determining the position, shape, and orientation of one or more objects in an environment using a joint segmentation and detection technique according to example embodiments of the present disclosure. One or more portions of the method 700 can be implemented by one or more devices (e.g., one or more computing devices) or systems including, for example, the vehicle 104, the computing system 108, and/or the operations computing system 150, shown in FIG. 1. Moreover, one or more portions of the method 700 can be implemented as an algorithm on the hardware components of one or more devices or systems (e.g., the vehicle 104, the computing system 108, and/or the operations computing system 150, shown in FIG. 1) to, for example, detect, track, and determine positions, shapes, and/or orientations of one or more objects within a predetermined distance of an autonomous vehicle, a robotic system, and/or a personal device, which can be performed using classification techniques including the use of a machine-learned model. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 702, the method 700 can include receiving sensor data which can include information based at least in part on sensor output which can be associated with one or more three-dimensional representations including one or more objects detected by one or more sensors (e.g., one or more sensors of an autonomous vehicle, a robotic system, and/or a personal computing device). In some embodiments, the sensor output can be associated with one or more areas (e.g., areas external to the vehicle 104 which can include the one or more objects) detected by the one or more sensors (e.g., the one or more sensors 128 depicted in FIG. 1). Further, in some embodiments, each of the one or more three-dimensional representations can include a plurality of points. For example, the computing system 108 can receive sensor data from one or more LIDAR sensors of the vehicle 104.

The one or more objects detected in the sensor data can include one or more objects external to the vehicle including one or more pedestrians (e.g., one or more persons standing, sitting, walking, and/or running); one or more implements carried and/or in contact with the one or more pedestrians (e.g., an umbrella, a cane, a cart, and/or a stroller); one or more buildings (e.g., one or more office buildings, one or more apartment buildings, and/or one or more houses); one or more roads; one or more road signs; one or more other vehicles (e.g., automobiles, trucks, buses, trolleys, motorcycles, airplanes, helicopters, boats, amphibious vehicles, and/or trains); and/or one or more cyclists (e.g., persons sitting or riding on bicycles).

Furthermore, the sensor data can be based at least in part on sensor output associated with one or more physical properties and/or attributes of the one or more objects. For example, the one or more sensor outputs can be associated with the location, position, shape, orientation, texture, velocity, acceleration, and/or physical dimensions (e.g., length, width, and/or height) of the one or more objects or portions of the one or more objects that is facing, or perpendicular to, the vehicle, robotic system, or personal computing device.

In some embodiments, each point of the plurality of points can be associated with a set of dimensions including a vertical dimension (e.g., a dimension associated with a height of an object), a width dimension (e.g., a dimension associated with a width of an object), and a length dimension (e.g., a dimension associated with a length of an object). Further, in some embodiments the set of dimensions can include three dimensions including three dimensions associated with an x axis, a y axis, and a z axis respectively. For example, the sensor data received by the computing system 108 can include LIDAR point cloud data associated with a plurality of points (e.g., three-dimensional points) corresponding to the surfaces of objects detected within sensor data obtained by the one or more LIDAR sensors of the vehicle 104.

Furthermore, in some embodiments, the plurality of points (e.g., the plurality of points from a three-dimensional LIDAR point cloud) can be represented as one or more voxels. For example, the computing system 108 can generate a plurality of voxels corresponding to the plurality of points. Further, one of the dimensions of the voxels (e.g., a height dimension) can be excluded to form a two-dimensional representation of the plurality of points. In this way, greater memory efficiency can be achieved and computational resources can be more effectively leveraged (e.g., the input to a machine-learning model can be modified so that the machine-learned model performs more efficiently).

At 704, the method 700 can include generating, based at least in part on the sensor data and a machine-learned model, one or more segments of the one or more three-dimensional representations. Each of the one or more segments can include a set of the plurality of points associated with at least one of the one or more objects. For example, the computing system 108 can generate one or more segments based at least in part on pixel-wise dense predictions of the position, shape, and/or orientation of the one or more objects.

In some embodiments, generating, based at least in part on the sensor data and a machine-learned model, the one or more segments at 704 can be further based at least in part on use of a thresholding technique. The thresholding technique can include a comparison of one or more attributes of each of the plurality of points to one or more threshold pixel attributes including brightness (e.g., luminance) and/or color information (e.g., chrominance). For example, a luminance threshold (e.g., a brightness level associated with one of the plurality of points) can be used to determine the one or more segments by masking the points that do not exceed the luminance threshold.

In some embodiments, the machine-learned model can be based at least in part on a plurality of classified features and classified object labels associated with training data. For example, the machine-learned model 1210 and/or the machine-learned model 1240 shown in FIG. 12 can receive training data (e.g., images of vehicles labeled as a vehicle, images of pedestrians labeled as pedestrians) as an input to a neural network of the machine-learned model. Further, the plurality of classified features can include a plurality of three-dimensional points associated with the sensor output from the one or more sensors (e.g., LIDAR point cloud data).

In some embodiments, the plurality of classified object labels can be associated with a plurality of aspect ratios (e.g., the proportional relationship between the length and width of an object) based at least in part on a set of physical dimensions (e.g., length and width) of the plurality of training objects. The set of physical dimensions can include a length, a width, and/or a height of the plurality of training objects.

At 706, the method 700 can include determining a position, a shape, and an orientation of each of the one or more objects in each of the one or more segments over a plurality of time intervals. For example, after the computing system 108 generates one or more segments (e.g., the one or more segments generated at 704, each of which can include a set of the plurality of points associated with one or more representations associated with the sensor output), the computing system 108 can use the position, shape, and orientation of each segment to determine or estimate the position, shape, and/or orientation of the associated object that is within the respective segment.

By way of further example, the computing system 108 can determine that a segment (e.g., a rectangular segment) two meters wide and five meters long can include an object (e.g., an automobile) that fits within the two meter wide and five meters long segment and has an orientation along its lengthwise axis. Further, the changing position of the segment over the plurality of time intervals (e.g., successive time intervals) can be used to determine that the orientation of the object is along the lengthwise axis of the segment in the direction of the movement of the segment over successive time intervals.

At 708, the method 700 can include determining, based at least in part on the machine-learned model and the position, the shape, and the orientation of each of the one or more objects, a predicted position, a predicted shape, and a predicted orientation of each of the one or more objects at a last one of the plurality of time intervals. For example, the computing system 108 can use the shape (e.g., rectangular) of an object (e.g., an automobile) from a bird's eye view perspective, over nine preceding time intervals to determine that the shape of the object will be the same (e.g., rectangular) in a tenth time interval.

At 710, the method 700 can include generating an output based at least in part on the predicted position, the predicted shape, or the predicted orientation of each of the one or more objects at the last one of the plurality of time intervals. For example, the computing system 108 can generate output including output data that can be used to provide one or more indications (e.g., graphical indications on a display configured to receive output data from the computing system 108) associated with detection of the one or more objects. By way of further example, the computing system 108 can generate output that can be used to display representations of the one or more objects including text labels to indicate different objects or object classes, symbols to indicate different objects or object classes, and directional indicators (e.g., lines) to indicate the orientation of an object. Furthermore, the output can include one or more control signals and/or data that can be used to activate and/or control the operation of one or more systems and/or devices including vehicles, robotic systems, and/or personal computing devices. For example, the output can be used by the computing system 108 to detect objects in an environment and control the movement of an autonomous vehicle or robot through the environment without contacting the detected objects.

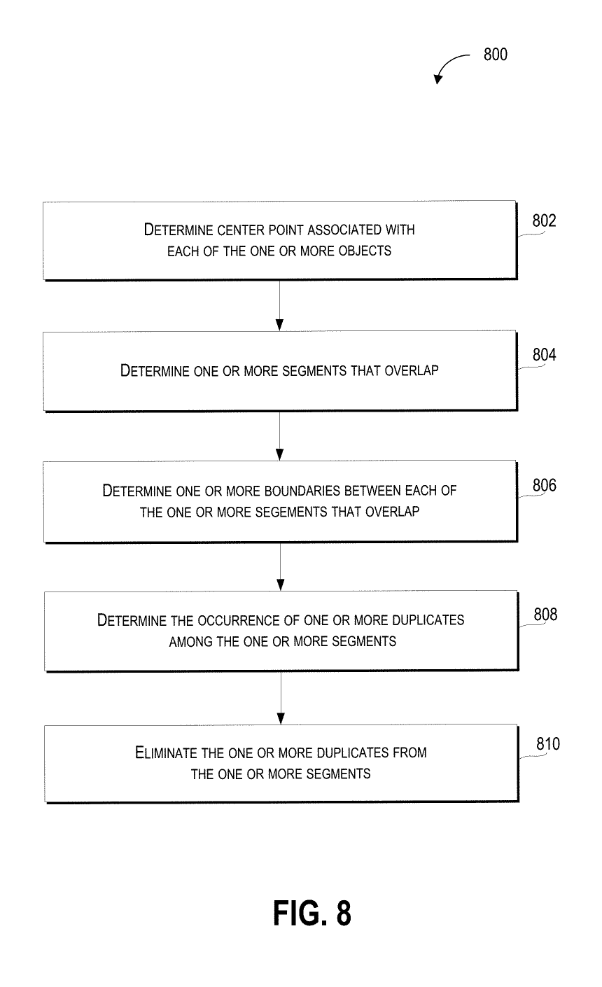

FIG. 8 depicts a flow diagram of an example method of determining object position, shape, and orientation using a joint segmentation and detection technique according to example embodiments of the present disclosure. One or more portions of the method 800 can be implemented by one or more devices (e.g., one or more computing devices) or systems including, for example, the vehicle 104, the computing system 108, and/or the operations computing system 150, shown in FIG. 1. Moreover, one or more portions of the method 800 can be implemented as an algorithm on the hardware components of one or more devices or systems (e.g., the vehicle 104, the computing system 108, and/or the operations computing system 150, shown in FIG. 1) to, for example, detect, track, and determine positions, shapes, and/or orientations of one or more objects within a predetermined distance of an autonomous vehicle, a robotic system, and/or a personal device, which can be performed using classification techniques including the use of a machine-learned model. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 802, the method 800 can include determining, based at least in part on the relative position of the plurality of points (e.g., the plurality of points of the method 1000), a center point associated with each of the one or more segments (e.g., the one or more segments of the method 1000). For example, the computing system 108 can use one or more feature detection techniques (e.g., edge detection, corner detection, and/or ridge detection) to detect the outline, boundary, and/or edge of the one or more segments and can determine a center point of a segment based on the distance between the detected outline, boundaries, and/or edges. As such, the center point of the segment can be used to predict a center point of an object located within the segment.

In some embodiments, determining the position, the shape, and the orientation of each of the one or more objects (e.g., each of the one or more objects in the method 700) can be based at least in part on the center point associated with each of the one or more segments.

At 804, the method 800 can include determining, based at least in part on the sensor data (e.g., the sensor data of the method 700/900/1000/1100) and the machine-learned model (e.g., the machine-learned model of the system 1000, the system 1200, and/or the method 700/900/1000/1100), the one or more segments that overlap (e.g., the one or more segments that overlap at least one other segment of the one or more segments). For example, the computing system 108 can determine the one or more segments that overlap based on the one or more segments covering the same portion of an area. By way of further example, when there are at least two segments, the at least two segments can be determined to overlap when the intersection over union (IoU) of the at least two segments of the one or more segments exceeds an IoU threshold.

In some embodiments, when there is only one segment, the one segment can be determined to overlap itself. In some other embodiments, when there is only one segment, the one segment can be determined not to overlap any segment.

At 806, the method 800 can include determining, based at least in part on the shape, the position, or the orientation of each of the one or more objects in the one or more segments, one or more boundaries between each of the one or more segments that overlap. For example, the computing system 108 can determine a boundary that divides the overlapping portion of the one or more segments that overlap in different ways including generating a boundary to equally divide the overlapping area between two or more segments, generating a boundary in which larger segments encompass a greater or lesser portion of the overlapping area, and/or generating a boundary in which the overlapping area is divided in proportion to the relative sizes of the one or more segments.

In some embodiments, the shape, the position, or the orientation of each of the one or more objects can be based at least in part on the one or more boundaries between each of the one or more segments. For example, the computing system 108 can determine that two segments that overlap and form an obtuse angle are part of a single segment that includes a single object (e.g., a truck pulling a trailer).

At 808, the method 800 can include determining, based at least in part on the position, the shape, or the orientation of the one or more objects in the one or more segments that overlap, the occurrence of one or more duplicates among the one or more segments. For example, the computing system 108 can determine the position of the one or more objects and a pair of segments that overlap. The computing system 108 can then determine that at least one segment of the pair of segments that overlap the same object of the one or more objects is a duplicate segment.

At 810, the method 800 can include eliminating (e.g., removing or excluding from use) the one or more duplicates from the one or more segments. For example, the computing system 108 can determine, based at least in part on the position of an object in a pair of segments that overlap, the intersection over union for each segment of the pair of segments with respect to the object. The computing system 108 can then determine that the segment with the lowest intersection over union is the duplicate segment that will be eliminated.

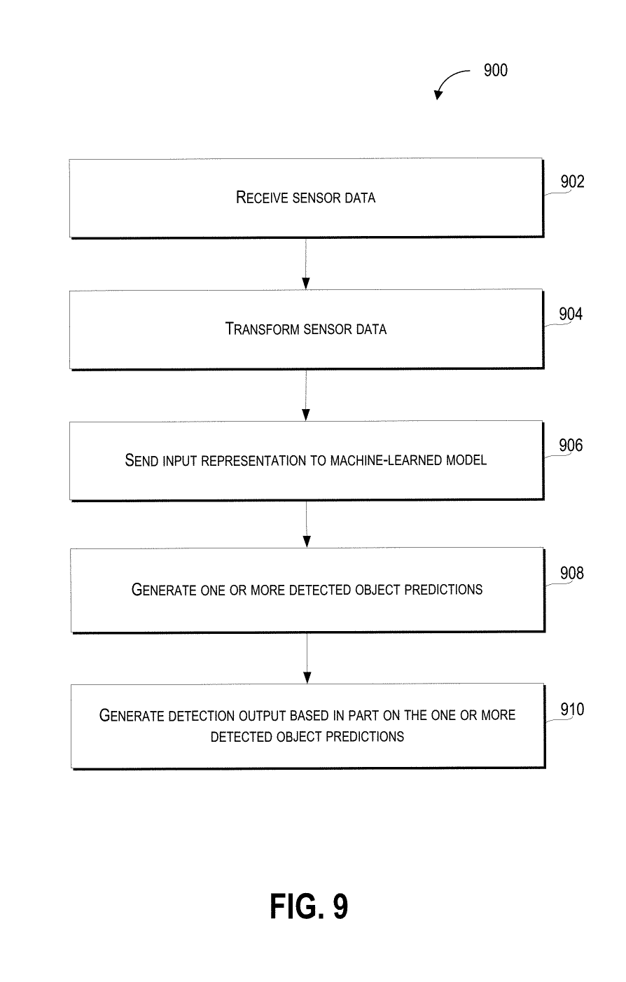

FIG. 9 depicts a flow diagram of an example method of training a machine-learned model according to example embodiments of the present disclosure. One or more portions of the method 900 can be implemented by one or more devices (e.g., one or more computing devices) or systems including, for example, the vehicle 104, the computing system 108, and/or the operations computing system 150, shown in FIG. 1. Moreover, one or more portions of the method 900 can be implemented as an algorithm on the hardware components of one or more devices or systems (e.g., the vehicle 104, the computing system 108, and/or the operations computing system 150, shown in FIG. 1) to, for example, detect, track, and determine positions, shapes, and/or orientations of one or more objects within a predetermined distance of an autonomous vehicle, a robotic system, and/or a personal device, which can be performed using classification techniques including the use of a machine-learned model. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, the method 900 can include receiving sensor data (e.g., the sensor data of the method 700) from one or more sensors (e.g., one or more sensors associated with an autonomous vehicle, which can include the vehicle 104). For example, the computing system 108 can receive sensor data including LIDAR point cloud data including three-dimensional points associated with one or more objects from one or more sensors of the vehicle 104.

In some embodiments, the sensor data can include information associated with a set of physical dimensions (e.g., the length, width, and/or height) of the one or more objects detected within the sensor data. Further, the sensor data can include one or more images (e.g., two-dimensional images including pixels or three-dimensional images including voxels). By way of example, the one or more objects detected within the sensor data can include one or more vehicles, pedestrians, foliage, buildings, unpaved road surfaces, paved road surfaces, bodies of water (e.g., rivers, lakes, streams, canals, and/or ponds), and/or geographic features (e.g., mountains and/or hills).

At 904, the method 900 can include transforming the sensor data into an input representation for use by the machine-learned model (e.g., the machine-learned model 1210 and/or the machine-learned model 1240 shown in FIG. 12). For example, the computing system 108 can transform (e.g., convert, modify, and/or change from one format or data structure into a different format or data structure) the sensor data into a data format that can be used by the machine-learned model. By way of further example, the computing system 108 can crop and/or reduce the resolution of images captured by the one or more sensors of the vehicle 104.

For example, standard convolutional neural networks can perform discrete convolutions and may operate on the assumption that the input lies on a grid. However, three-dimensional point clouds can be unstructured, and thus it may not be possible to directly apply standard convolutions. One choice to convert three-dimensional point clouds to a structured representation is to use voxelization to form a three-dimensional grid, where each voxel can include statistics of the points that lie within that voxel. However, this representation may not be optimal as it may have sub-optimal memory efficiency. Furthermore, convolution operations in three-dimensions can result in wasted computation since most voxels may be empty.

In some embodiments, a two-dimensional representation of a scene in bird's eye view (BEV) can be used. This two-dimensional representation can be suitable as it is memory efficient and objects such as vehicles do not overlap. This can simplify the detection process when compared to other representations such as range view which projects the points to be seen from the observer's perspective. Another advantage is that the network reasons in metric space, and thus the network can exploit prior information about the physical dimensions of one or more objects.

In some embodiments, to build an input representation, a rectangular region of interest of size H×W m² can first be set in real world coordinates centered at the position of the object (e.g., an autonomous vehicle). The three-dimensional points within this region can then be projects to the BEV and discretized with a resolution of 0.1 meters per cell. This can result in a two-dimensional grid of size 10 H×10 W (e.g., ten meters high by ten meters wide).

Two types of information can then be encoded into the input representation: the height of each point as well as the reflectance value of each point. To encode height, the three-dimensional point cloud can be divided equally into M separate bins, and an occupancy map can be generated per bin. To encode reflectance, a “reflectance image” can be computed with the same size as the two-dimensional grid. The pixel values of this image can then be assigned as the reflectance values (normalized to be in the range of [0, 1]). If there is no point in that location, the pixel value can be set to be zero. As a result, an input representation in the form of a 10 H×10 W×(M+1) tensor can be obtained.

At 906, the method 900 can include sending the sensor data to the machine-learned object detection model. For example, the sensor data can be sent to the machine-learned model via a wired and/or wireless communication channel. Further, the machine-learned model can be trained to receive an input including data (e.g., the sensor data) and, responsive to receiving the input, generate an output including one or more detected object predictions. For example, the vehicle 104 can send the sensor data to the computing system 1202 and/or the machine-learning computing system 1230 of FIG. 12. In some embodiments, the machine-learned model can include some or all of the features of the computing system 108, one or more machine-learned models 1210, and/or the one or more machine-learned models 1240.

In some embodiments, the machine-learned model can use one or more classification processes or classification techniques based at least in part on a neural network (e.g., deep neural network, convolutional neural network), gradient boosting, a support vector machine, a logistic regression classifier, a decision tree, ensemble model, Bayesian network, k-nearest neighbor model (KNN), and/or other classification processes or classification techniques which can include the use of linear models and/or non-linear models. By way of further example, specific example embodiments of machine-learned models to which transformed sensor data is sent are depicted by the object detection system 400 shown in FIG. 4, the neural network 500 shown in FIG. 5, and/or the geometry output parameterization shown in FIG. 6.

At 908, the method 900 can include generating, based at least in part on output from the machine-learned object detection model, one or more detected object predictions including one or more positions, one or more shapes, or one or more orientations of the one or more objects. For example, the computing system 108, the one or more machine-learned models 1210, and/or the one or more machine-learned models 1240, can generate, based at least in part on the sensor data, an output that includes one or more detected object predictions including the position (e.g., a geographic position including latitude and longitude and/or a relative position of each of the one or more objects relative to a sensor position) of one or more detected objects, the shape of one or more objects (e.g., the shape of each of the one or more objects detected in the sensor data), and the orientation of one or more objects (e.g., the heading of each of the one or more objects detected in the sensor data).

In some embodiments, generating, based at least in part on output from the machine-learned object detection model, one or more detected object predictions at 706 can include use of a classification branch and/or a regression branch of a neural network (e.g., a convolutional neural network). The classification branch of the neural network can output a one channel feature map including a confidence score representing a probability that a pixel belongs to an object.

Further, the regression branch of the neural network can output six channel feature maps including two channels (e.g., cos(θ) and sin(θ)) for an object heading angle, two channels (e.g., x (x coordinate) and y (y coordinate)) for an object's center position, and two channels for an object's size (e.g., w (width) and l (length)).

At 910, the method 900 can include generating detection output based at least in part on the one or more detected object predictions. The detection output can include one or more indications associated with the one or more positions, the one or more shapes, or the one or more orientations of the one or more objects over a plurality of time intervals. For example, the computing system 1202 and/or the machine-learning computing system 1230 can generate object data that can be used to graphically display the position, shape, and/or orientation of the one or more objects on a display device (e.g., an LCD monitor).

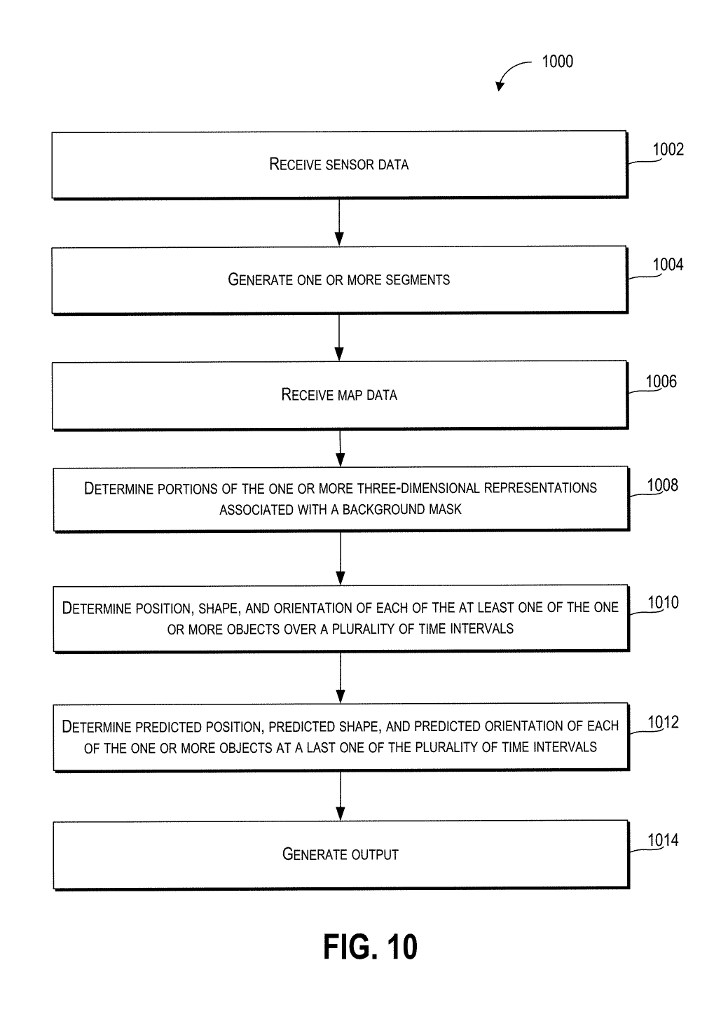

FIG. 10 depicts a flow diagram of an example method of determining the position, shape, and orientation of one or more objects in an environment using a joint segmentation and detection technique according to example embodiments of the present disclosure. One or more portions of the method 1000 can be implemented by one or more devices (e.g., one or more computing devices) or systems including, for example, the vehicle 104, the computing system 108, and/or the operations computing system 150, shown in FIG. 1. Moreover, one or more portions of the method 1000 can be implemented as an algorithm on the hardware components of one or more devices or systems (e.g., the vehicle 104, the computing system 108, and/or the operations computing system 150, shown in FIG. 1) to, for example, detect, track, and determine positions, shapes, and/or orientations of one or more objects within a predetermined distance of an autonomous vehicle, a robotic system, and/or a personal device, which can be performed using classification techniques including the use of a machine-learned model. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 1002, the method 1000 can include receiving sensor data (e.g., the sensor data of the method 700). The sensor data can include information based at least in part on sensor output associated with one or more areas that include one or more objects detected by one or more sensors (e.g., one or more sensors of an autonomous vehicle). For example, the computing system 108 can receive sensor data from one or more image capture devices and/or sensors of a vehicle (e.g., an autonomous vehicle, the vehicle 104).

In some embodiments, the one or more areas associated with the sensor data, which can be received at 1002, can be associated with one or more multi-dimensional representations (e.g., one or more data structures to represent one or more objects) that include a plurality of points (e.g., a plurality of points from a LIDAR point cloud and/or a plurality of points associated with an image comprising a plurality of pixels). The one or more objects can include one or more objects external to the vehicle including one or more pedestrians (e.g., one or more persons standing, sitting, walking, and/or running); one or more implements carried and/or in contact with the one or more pedestrians (e.g., an umbrella, a cane, a cart, and/or a stroller); one or more buildings (e.g., one or more office buildings, one or more apartment buildings, and/or one or more houses); one or more roads; one or more road signs; one or more other vehicles (e.g., automobiles, trucks, buses, trolleys, motorcycles, airplanes, helicopters, boats, amphibious vehicles, and/or trains); and/or one or more cyclists (e.g., persons sitting or riding on bicycles).

Furthermore, the sensor data received at 1002 can be based at least in part on sensor output associated with one or more physical properties and/or attributes of the one or more objects. For example, the one or more sensor outputs can be associated with the location, position, shape, orientation, texture, velocity, acceleration, and/or physical dimensions (e.g., length, width, and/or height) of the one or more objects or portions of the one or more objects (e.g., a side of the one or more objects that is facing the vehicle or perpendicular to the vehicle).

In some embodiments, the sensor data received at 1002 can include information associated with a set of three-dimensional points (e.g., x, y, and z coordinates) associated with one or more physical dimensions (e.g., the length, width, and/or height) of the one or more objects, one or more locations (e.g., physical locations) of the one or more objects, and/or one or more locations of the one or more objects relative to a point of reference (e.g., the location of an object relative to a portion of an autonomous vehicle, a robotic system, a personal computing device, and/or another one of the one or more objects).

The one or more sensors from which sensor data is received at 1002 can include one or more LIDAR devices, one or more radar devices, one or more sonar devices, one or more thermal sensors, and/or one or more image sensors (e.g., one or more cameras or other image capture devices).

At 1004, the method 1000 can include generating one or more segments of the one or more three-dimensional representations. The generation of the one or more segments can be based at least in part on the sensor data (e.g., the sensor data received at 1002) and/or a machine-learned model. Each of the one or more segments can be associated with at least one of the one or more objects and/or an area within the sensor data. Further, each of the one or more segments can encompass a portion of the one or more objects detected within the sensor data.

For example, the one or more segments can be associated with regions (e.g., pixel-sized regions) that the computing system 108 determines to have a greater probability of including a portion of one or more objects (e.g., one or more objects that are determined to be of interest). In some embodiments, the machine-learned model can be based at least in part on a plurality of classified features and classified object labels associated with training data. For example, the machine-learned model 1210 and/or the machine-learned model 1240 shown in FIG. 12 can receive training data (e.g., images of vehicles labeled as a vehicle, images of pedestrians labeled as pedestrians) as an input to a neural network of the machine-learned model. Further, the plurality of classified features can include a plurality of three-dimensional points associated with the sensor output from the one or more sensors (e.g., LIDAR point cloud data).

In some embodiments, the plurality of classified object labels can be associated with a plurality of aspect ratios (e.g., the proportional relationship between the length and width of an object) based at least in part on a set of physical dimensions (e.g., length and width) of the plurality of training objects. The set of physical dimensions can include a length, a width, and/or a height of the plurality of training objects. a rectangular shape with an aspect ratio that would conforms to a motor vehicle).

At 1006, the method 1000 can include receiving map data. The map data can be associated with the one or more areas including areas detected by one or more sensors (e.g., the one or more sensors 128 of the vehicle 104 which is depicted in FIG. 1). Further, the map data can include information associated with one or more areas including one or more background portions of the one or more areas that do not include one or more objects that are determined to be of interest (e.g., one or more areas that are not regions of interest). For example, the map data can include information indicating portions of an area that are road, buildings, trees, or bodies of water. For example, the computing system 108 can receive map data from the one or more remote computing devices 130, which can be associated with one or more map providing services that can send the map data to one or more requesting computing devices which can include the computing system 108.

Further, the map data can include information associated with the classification of portions of an area (e.g., an area traversed by the vehicle 104). For example, the map data can include the classification of portions of an area as paved road (e.g., streets and/or highways), unpaved road (e.g., dirt roads), a building (e.g., houses, apartment buildings, office buildings, and/or shopping malls), a lawn, a sidewalk, a parking lot, a field, a forest, and/or a body of water.

At 1008, the method 1000 can include determining, based at least in part on the map data, portions of the one or more segments that are associated with a region of interest mask (e.g., a region of interest mask that excludes regions that are not of interest, which can include road and street portions of the map) including a set of the plurality of points not associated with the one or more objects. For example, the sensor data (e.g., the sensor data of the method 1000) can include map data associated with the location of one or more roads, streets, buildings, and/or other objects detected within the sensor data.

Further, the computing system 108 can determine, based at least in part on the sensor data, one or more portions of the map data that are regions of interest (e.g., areas that are associated with a greater probability of including an object of interest). The computing system 108 can then determine a region of interest mask based on the areas that are not part of the regions of interest (e.g., a swimming pool area can be part of the region of interest mask) in which certain classes of objects (e.g., automobiles) are likely to be located.

In some embodiments, the one or more segments do not include the one or more background portions of the one or more areas (e.g., the one or more background portions are excluded from the one or more segments).

Furthermore, in some embodiments, determining the one or more portions of the one or more segments that are part of the background can be performed through use of a filtering technique including, for example, non-maximum suppression. For example, the computing system 108 can use non-maximum suppression to analyze one or more images (e.g., two-dimensional images including pixels or three-dimensional images including voxels) of the sensor data and set the portions of the image (e.g., pixels, voxels) that are not part of the local maxima to zero (e.g., set the portions as a background to be excluded from the one or more segments).

At 1010, the method 1000 can include determining a position, a shape, and/or an orientation of each of the one or more objects in each of the one or more segments over a plurality of time intervals. For example, the computing system 108 can determine the position (e.g., location), shape (e.g., physical dimensions including length, width, and/or height), and/or orientation (e.g., compass orientation) of the one or more objects and/or sets of the one or more objects (e.g., a set of objects including a truck object pulling a trailer object). For example, the computing system 108 can use LIDAR data associated with the state of one or more objects over the past one second to determine the position, shape, and orientation of each of the one or more objects in each of the one or more segments during ten (10) one-tenth of a second (0.1 seconds) intervals over one second time period between the current time and one second ago.

At 1012, the method 1000 can include determining, based at least in part on the machine-learned model and the position, the shape, and the orientation of each of the one or more objects, a predicted position, a predicted shape, and a predicted orientation of each of the one or more objects at a last one of the plurality of time intervals. For example, the computing system 108 can provide data including the position, shape, and orientation of each of the one or more objects as input for the machine-learned model.

The machine-learned model (e.g., the machine-learned model 1210 and/or the machine-learned model 1240) can be trained (e.g., trained prior to receiving the input) to output the predicted position, predicted shape, and predicted orientation of the one or more objects based on the input. By way of further example, the computing system 108 can use the footprint shape (e.g., rectangular) of an object (e.g., an automobile) over three time intervals to determine that the shape of the object will be the same (e.g., rectangular) in a fourth time interval that follows the three preceding time intervals.

At 1014, the method 1000 can include generating an output. The output can be based at least in part on the predicted position, the predicted shape, or the predicted orientation of each of the one or more objects at the last one of the plurality of time intervals. Further, the output including data that can be used to provide one or more indications (e.g., graphical indications on a display device associated with the computing system 108) associated with detection of the one or more objects. By way of further example, the computing system 108 can generate output that can be used to display representations (e.g., representations on a display device) of the one or more objects including using color coding to indicate different objects or object classes; different shapes to indicate different objects or object classes; and directional indicators (e.g., arrows) to indicate the orientation of an object.

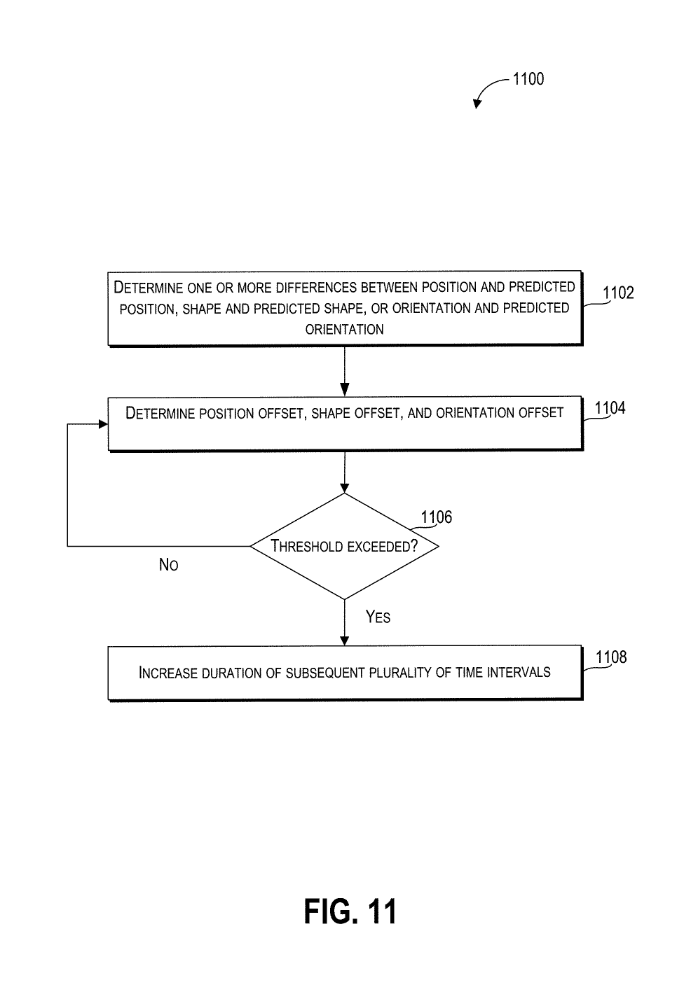

FIG. 11 depicts a flow diagram of an example method of determining the position, shape, and orientation of one or more objects in an environment using a joint segmentation and detection technique according to example embodiments of the present disclosure. One or more portions of the method 1100 can be implemented by one or more devices (e.g., one or more computing devices) or systems including, for example, the vehicle 104, the computing system 108, and/or the operations computing system 150, shown in FIG. 1. Moreover, one or more portions of the method 1100 can be implemented as an algorithm on the hardware components of one or more devices or systems (e.g., the vehicle 104, the computing system 108, and/or the operations computing system 150, shown in FIG. 1) to, for example, detect, track, and determine positions, shapes, and/or orientations of one or more objects within a predetermined distance of an autonomous vehicle, a robotic system, and/or a personal computing device, which can be performed using classification techniques including the use of a machine-learned model. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 1102, the method 1100 can include determining, for each of the one or more objects (e.g., the one or more objects detected in the method 700 or the method 1000), one or more differences between the position (e.g., a location) of each of the one or more objects and the predicted position of each of the one or more objects; the shape of each of the one or more objects (e.g., the shape of the surface of each of the one or more objects) and the predicted shape of each of the one or more objects; and/or the orientation of each of the one or more objects and the predicted orientation of each of the one or more objects. For example, the computing system 108 can determine one or more differences between the position and the current position of the one or more objects based at least in part on a comparison of the current position of an object and the predicted position of the object.

At 1104, the method 1100 can include determining, for each of the one or more objects (e.g., the one or more objects detected in the method 700 or the method 1000), based at least in part on the differences between the position (e.g., the position of an object determined in the method 700 or the method 1000) and the predicted position (e.g., the predicted position of an object determined in the method 700 or the method 1000), the shape (e.g., the shape of an object determined in the method 700 or the method 1000) and the predicted shape (e.g., the predicted shape of an object determined in the method 700 or the method 1000), and/or the orientation (e.g., the orientation of an object determined in the method 700 or the method 1000) and the predicted orientation (e.g., the predicted orientation of an object determined in the method 700 or the method 1000), a respective position offset, shape offset, and/or orientation offset. For example, the computing system 108 can use the determined difference between the position and the predicted position when determining the predicted position of an object at a subsequent time interval.

In some embodiments, a subsequent predicted position (e.g., a predicted position at a time interval subsequent to the time interval for the predicted position), a subsequent predicted shape (e.g., a predicted shape at a time interval subsequent to the time interval for the predicted shape), and a subsequent predicted orientation (e.g., a predicted orientation at a time interval subsequent to the time interval for the predicted orientation) of each of the one or more objects in a time subsequent to the last one of the plurality of time intervals can be based at least in part on the position offset, the shape offset, and/or the orientation offset.

At 1106, the method 1100 can, responsive to determining that the position offset exceeds a position threshold, the shape offset exceeds a shape threshold, and/or that the orientation offset exceeds an orientation threshold, proceed to 1108. For example, the computing system 108 can determine that the position threshold has been exceeded based on a comparison of position data (e.g., data including one or more values associated with the position of an object) to position threshold data (e.g., data including one or more values associated with a position threshold value).

Responsive to determining that the position offset does not exceed a position threshold, the shape offset does not exceed a shape threshold, and/or that the orientation offset does not exceed an orientation threshold, the method 1100 can return to 1102, 1104, or end.

At 1108, the method 1100 can include increasing, a duration of the subsequent plurality of time intervals used to determine the subsequent predicted position, the subsequent predicted shape, or the subsequent predicted orientation respectively. For example, when the magnitude of the position offset is large (e.g., a quantity that is determined to have a predetermined amount of impact on the accuracy and/or precision of detecting the one or more objects), the computing system 108 can increase the duration of the plurality of time intervals used in determining the orientation of the one or more objects from half a second to one second of sensor output associated with the orientation of the one or more objects. In this way, by using more data (e.g., orientation data that is associated with a longer duration of time receiving sensor output), the computing system 108 can more accurately predict the positions of the one or more objects.

FIG. 12 depicts a diagram of an example system including a machine learning computing system according to example embodiments of the present disclosure. The example system 1200 includes a computing system 1202 and a machine learning computing system 1230 that are communicatively coupled (e.g., configured to send and/or receive signals and/or data) over one or more networks 1280.

In some implementations, the computing system 1202 can perform various operations including the determination of an object's state including the object's position, shape, and/or orientation. In some implementations, the computing system 1202 can be included in an autonomous vehicle (e.g., vehicle 104 of FIG. 1). For example, the computing system 1202 can be on-board the autonomous vehicle. In other implementations, the computing system 1202 is not located on-board the autonomous vehicle. For example, the computing system 1202 can operate offline to determine an object's state including the object's position, shape, and/or orientation. The computing system 1202 can include one or more distinct physical computing devices.

The computing system 1202 includes one or more processors 1212 and a memory 1214. The one or more processors 1212 can be any suitable processing device (e.g., a processor core, a microprocessor, an ASIC, a FPGA, a controller, a microcontroller, etc.) and can be one processor or a plurality of processors that are operatively connected. The memory 1214 can include one or more non-transitory computer-readable storage media, such as RAM, ROM, EEPROM, EPROM, one or more memory devices, flash memory devices, etc., and combinations thereof.

The memory 1214 can store information that can be accessed by the one or more processors 1212. For instance, the memory 1214 (e.g., one or more non-transitory computer-readable storage mediums, memory devices) can store data 1216 that can be obtained, received, accessed, written, manipulated, created, and/or stored. The data 1216 can include, for instance, examples as described herein. In some implementations, the computing system 1202 can obtain data from one or more memory devices that are remote from the computing system 1202.

The memory 1214 can also store computer-readable instructions 1218 that can be executed by the one or more processors 1212. The instructions 1218 can be software written in any suitable programming language or can be implemented in hardware. Additionally, or alternatively, the instructions 1218 can be executed in logically and/or virtually separate threads on processor(s) 1212.

For example, the memory 1214 can store instructions 1218 that when executed by the one or more processors 1212 cause the one or more processors 1212 to perform any of the operations and/or functions described herein, including, for example, detecting and/or determining the position, shape, and/or orientation of one or more objects.

According to an aspect of the present disclosure, the computing system 1202 can store or include one or more machine-learned models 1210. As examples, the machine-learned models 1210 can be or can otherwise include various machine-learned models such as, for example, neural networks (e.g., deep neural networks), support vector machines, decision trees, ensemble models, k-nearest neighbors models, Bayesian networks, logistic regression classification, boosted forest classification, or other types of models including linear models and/or non-linear models. Example neural networks include feed-forward neural networks, recurrent neural networks (e.g., long short-term memory recurrent neural networks), or other forms of neural networks.

In some implementations, the computing system 1202 can receive the one or more machine-learned models 1210 from the machine learning computing system 1230 over the one or more networks 1280 and can store the one or more machine-learned models 1210 in the memory 1214. The computing system 1202 can then use or otherwise implement the one or more machine-learned models 1210 (e.g., by processor(s) 1212). In particular, the computing system 1202 can implement the machine-learned model(s) 1210 to detect and/or determine the position, orientation, and/or shape of one or more objects.

The machine learning computing system 1230 includes one or more processors 1232 and a memory 1234. The one or more processors 1232 can be any suitable processing device (e.g., a processor core, a microprocessor, an ASIC, a FPGA, a controller, a microcontroller, etc.) and can be one processor or a plurality of processors that are operatively connected. The memory 1234 can include one or more non-transitory computer-readable storage media, such as RAM, ROM, EEPROM, EPROM, one or more memory devices, flash memory devices, etc., and combinations thereof.

The memory 1234 can store information that can be accessed by the one or more processors 1232. For instance, the memory 1234 (e.g., one or more non-transitory computer-readable storage mediums, memory devices) can store data 1236 that can be obtained, received, accessed, written, manipulated, created, and/or stored. The data 1236 can include, for instance, include examples as described herein. In some implementations, the machine learning computing system 1230 can obtain data from one or more memory device(s) that are remote from the machine learning computing system 1230.

The memory 1234 can also store computer-readable instructions 1238 that can be executed by the one or more processors 1232. The instructions 1238 can be software written in any suitable programming language or can be implemented in hardware. Additionally, or alternatively, the instructions 1238 can be executed in logically and/or virtually separate threads on processor(s) 1232.

For example, the memory 1234 can store instructions 1238 that when executed by the one or more processors 1232 cause the one or more processors 1232 to perform any of the operations and/or functions described herein, including, for example, determining the position, shape, and/or orientation of an object.

In some implementations, the machine learning computing system 1230 includes one or more server computing devices. If the machine learning computing system 1230 includes multiple server computing devices, such server computing devices can operate according to various computing architectures, including, for example, sequential computing architectures, parallel computing architectures, or some combination thereof.

In addition or alternatively to the model(s) 1210 at the computing system 1202, the machine learning computing system 1230 can include one or more machine-learned models 1240. As examples, the machine-learned models 1240 can be or can otherwise include various machine-learned models such as, for example, neural networks (e.g., deep neural networks), support vector machines, decision trees, ensemble models, k-nearest neighbors models, Bayesian networks, logistic regression classification, boosted forest classification, or other types of models including linear models and/or non-linear models. Example neural networks include feed-forward neural networks, recurrent neural networks (e.g., long short-term memory recurrent neural networks, and/or other forms of neural networks.

As an example, the machine learning computing system 1230 can communicate with the computing system 1202 according to a client-server relationship. For example, the machine learning computing system 1230 can implement the machine-learned models 1240 to provide a web service to the computing system 1202. For example, the web service can provide results including the physical dimensions, positions, shapes, and/or orientations of one or more objects.

Thus, machine-learned models 1210 can be located and used at the computing system 1202 and/or machine-learned models 1240 can be located and used at the machine learning computing system 1230.

In some implementations, the machine learning computing system 1230 and/or the computing system 1202 can train the machine-learned models 1210 and/or 1240 through use of a model trainer 1260. The model trainer 1260 can train the machine-learned models 1210 and/or 1240 using one or more training or learning algorithms. One example training technique is backwards propagation of errors.

In some implementations, the model trainer 1260 can perform supervised training techniques using a set of labeled training data. In other implementations, the model trainer 1260 can perform unsupervised training techniques using a set of unlabeled training data. The model trainer 1260 can perform a number of generalization techniques to improve the generalization capability of the models being trained. Generalization techniques include weight decays, dropouts, or other techniques.

In particular, the model trainer 1260 can train a machine-learned model 1210 and/or 1240 based on a set of training data 1262. The training data 1262 can include, for example, various features of one or more objects. The model trainer 1260 can be implemented in hardware, firmware, and/or software controlling one or more processors.

In some embodiments, the model trainer 1260 can use a multi-task loss to train the network. Specifically, cross-entropy loss can be used on the classification output and a smooth l₁ loss on the regression output. The classification loss can be summed over all locations on the output map. A class imbalance can occur since a large proportion of the scene belongs to background. To stabilize the training, the focal loss can be adopted with the same hyper-parameter to re-weight the positive and negative samples.

In some embodiments, a biased sampling strategy for positive samples may lead to more stable training. Regression loss can be computed over all positive locations only. During inference, the computed BEV (bird's eye view) LIDAR representation can be input to the network and one channel of confidence score and six channels of geometry information can be obtained as output. The geometry information can be decoded into oriented bounding box only on positions with a confidence score above a certain threshold. Further, in some embodiments non-Maximum suppression can be used to get or determine the final detections. The sum of the classification loss over locations on the output map can be expressed as follows:

$${L}_{total} = cross\_entropy ( q , y ) + {smooth}_{{L}_{1}} ( p - g )$$

$$cross\_entropy ( q , y ) = \{ \begin{matrix}- log ( p ) & if y = 1 \\ - log ( 1 - p ) & otherwise\end{matrix} , \\ {smooth}_{{L}_{1}} ( x ) = \{ \begin{matrix}0.5 {x}^{2} & if \vert x \vert < 1 \\ \vert x \vert - 0.5 & otherwise\end{matrix} ,$$

In some embodiments, the network can be fully trained end-to-end from scratch via gradient descent. The weights can be initialized with Xavier initialization and all bias can be set to zero (0). The detector can be trained with stochastic gradient descent using a batch size of four (4) on a single graphics processing unit (GPU). The network can be trained with a learning rate of 0.001 for sixty thousand (60,000) iterations, and the network can be decayed by 0.1 for another fifteen thousand (15,000) iterations. Further, a weight decay of 1e-5 and a momentum of 0.9 can be used.

The computing system 1202 can also include a network interface 1224 used to communicate with one or more systems or devices, including systems or devices that are remotely located from the computing system 1202. The network interface 1224 can include any circuits, components, software, etc. for communicating with one or more networks (e.g., the network(s) 1280).

In some implementations, the network interface 1224 can include, for example, one or more of a communications controller, receiver, transceiver, transmitter, port, conductors, software and/or hardware for communicating data. Further, the machine learning computing system 1230 can include a network interface 1264, which can include similar features as described relative to network interface 1224.

The network(s) 1280 can include any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 1280 can be accomplished, for instance, via a network interface using any type of protocol, protection scheme, encoding, format, and/or packaging.

FIG. 12 illustrates one example computing system 1200 that can be used to implement the present disclosure. Other computing systems can be used as well. For example, in some implementations, the computing system 1202 can include the model trainer 1260 and the training dataset 1262. In such implementations, the machine-learned models 1210 can be both trained and used locally at the computing system 1202. As another example, in some implementations, the computing system 1202 is not connected to other computing systems.

In addition, components illustrated and/or discussed as being included in one of the computing systems 1202 or 1230 can instead be included in another of the computing systems 1202 or 1230. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of object detection, the computer-implemented method comprising:
receiving, by a computing system comprising one or more computing devices, sensor data comprising information based at least in part on sensor output from one or more sensors, the sensor output associated with one or more three-dimensional representations comprising one or more objects detected by the one or more sensors, wherein each of the one or more three-dimensional representations comprises a plurality of points;
generating, by the computing system, based at least in part on the sensor data and a machine-learned model, one or more segments of the one or more three-dimensional representations, wherein each of the one or more segments comprises a set of the plurality of points associated with at least one of the one or more objects;
determining, by the computing system, a position, a shape, and an orientation of each of the one or more objects in each of the one or more segments over a plurality of time intervals;
determining, by the computing system, based at least in part on the machine-learned model and the position, the shape, and the orientation of each of the one or more objects, a predicted position, a predicted shape, and a predicted orientation of each of the one or more objects at a last one of the plurality of time intervals; and
generating, by the computing system, an output based at least in part on the predicted position, the predicted shape, or the predicted orientation of each of the one or more objects at the last one of the plurality of time intervals, wherein the output comprises one or more indications associated with detection of the one or more objects.

2. The computer-implemented method of claim 1, further comprising:
receiving, by the computing system, map data comprising information associated with one or more areas corresponding to the one or more three-dimensional representations; and
determining, by the computing system, based at least in part on the map data, portions of the one or more segments that are associated with a region of interest mask comprising a set of the plurality of points not associated with the one or more objects.

3. The computer-implemented method of claim 1, further comprising:
determining, by the computing system, based at least in part on the relative position of the plurality of points, a center point associated with each of the one or more segments, wherein the determining the position, the shape, and the orientation of each of the one or more objects is based at least in part on the center point associated with each of the one or more segments.

4. The computer-implemented method of claim 1, further comprising:
determining, by the computing system, based at least in part on the sensor data and the machine-learned model, the one or more segments that overlap; and
determining, by the computing system, based at least in part on the shape, the position, or the orientation of each of the one or more objects in the one or more segments, one or more boundaries between each of the one or more segments that overlap, wherein the shape, the position, or the orientation of each of the one or more objects is based at least in part on the one or more boundaries between each of the one or more segments.

5. The computer-implemented method of claim 4, further comprising:
determining, by the computing system, based at least in part on the position, the shape, or the orientation of the one or more objects in the one or more segments that overlap, the occurrence of one or more duplicates among the one or more segments; and
eliminating, by the computing system, the one or more duplicates from the one or more segments.

6. The computer-implemented method of claim 1, wherein each of the plurality of points is associated with a set of dimensions comprising a vertical dimension, a latitudinal dimension, and a longitudinal dimension.

7. The computer-implemented method of claim 1, wherein the determining the one or more segments is based at least in part on a thresholding technique comprising comparison of one or more attributes of each of the plurality of points to one or more threshold pixel attributes comprising luminance or chrominance.

8. The computer-implemented method of claim 1, wherein the one or more segments are based at least in part on pixel-wise dense predictions of the position, shape, or orientation of the one or more objects.

9. The computer-implemented method of claim 1, wherein the sensor output comprises a plurality of three-dimensional points associated with surfaces of the one or more objects.

10. The computer-implemented method of claim 1, wherein the one or more sensors comprise one or more light detection and ranging devices (LIDAR), one or more radar devices, one or more sonar devices, one or more thermal sensors, or one or more image sensors.

11. An object detection system, comprising:
one or more processors;
a machine-learned object detection model trained to receive sensor data and, responsive to receiving the sensor data, generate output comprising one or more detected object predictions;
a memory comprising one or more computer-readable media, the memory storing computer-readable instructions that when executed by the one or more processors cause the one or more processors to perform operations comprising:
receiving sensor data from one or more sensors, wherein the sensor data comprises information associated with a set of physical dimensions of one or more objects;
sending the sensor data to the machine-learned object detection model; and
generating, based at least in part on output from the machine-learned object detection model, one or more detected object predictions comprising one or more positions, one or more shapes, or one or more orientations of the one or more objects.

12. The object detection system of claim 11, further comprising:
generating, by the computing system, detection output based at least in part on the one or more detected object predictions, wherein the detection output comprises one or more indications associated with the one or more positions, the one or more shapes, or the one or more orientations of the one or more objects over a plurality of time intervals.

13. The object detection system of claim 11, wherein the machine-learned object detection model comprises a convolutional neural network, a recurrent neural network, a recursive neural network, gradient boosting, a support vector machine, or a logistic regression classifier.

14. A computing device comprising:
one or more processors;
a memory comprising one or more computer-readable media, the memory storing computer-readable instructions that when executed by the one or more processors cause the one or more processors to perform operations comprising:
receiving sensor data comprising information based at least in part on sensor output associated with one or more three-dimensional representations comprising one or more objects detected by one or more sensors, wherein each of the one or more three-dimensional representations comprises a plurality of points;
generating, based at least in part on the sensor data and a machine-learned model, one or more segments of the one or more three-dimensional representations, wherein each of the one or more segments comprises a set of the plurality of points associated with at least one of the one or more objects;
determining a position, a shape, and an orientation of each of the one or more objects in each of the one or more segments over a plurality of time intervals;
determining, based at least in part on the machine-learned model and the position, the shape, and the orientation of each of the one or more objects, a predicted position, a predicted shape, and a predicted orientation of each of the one or more objects at a last one of the plurality of time intervals; and
generating an output based at least in part on the predicted position, the predicted shape, or the predicted orientation of each of the one or more objects at the last one of the plurality of time intervals, wherein the output comprises one or more indications associated with detection of the one or more objects.

15. The computing device of claim 14, further comprising:
determining, for each of the one or more objects, one or more differences between the position and the predicted position, the shape and the predicted shape, or the orientation and the predicted orientation;
determining, for each of the one or more objects, based at least in part on the differences between the position and the predicted position, the shape and the predicted shape, or the orientation and the predicted orientation, a position offset, a shape offset, or an orientation offset respectively, wherein a subsequent predicted position, a subsequent predicted shape, and a subsequent predicted orientation of each of the one or more objects in a time subsequent to the last one of the plurality of time intervals is based at least in part on the position offset, the shape offset, or the orientation offset.

16. The computing device of claim 15, further comprising:
responsive to the position offset exceeding a position threshold, the shape offset exceeding a shape threshold, or the orientation offset exceeding an orientation threshold, increasing, a duration of the subsequent plurality of time intervals used to determine the subsequent predicted position, the subsequent predicted shape, or the subsequent predicted orientation respectively.

17. The computing device of claim 14, wherein the machine-learned model is based at least in part on a plurality of classified features and classified object labels associated with training data, and wherein the plurality of classified features comprise a plurality of three-dimensional points associated with the sensor output from the one or more sensors.

18. The computing device of claim 17, wherein the plurality of classified object labels is associated with a plurality of aspect ratios based at least in part on a set of physical dimensions of the plurality of training objects, the set of physical dimensions comprising a length, a width, or a height of the plurality of training objects, wherein a size or shape of the one or more segments is based at least in part on the plurality of aspect ratios.

19. The computing device of claim 14, wherein the machine-learned model comprises a deep convolutional neural network.

20. The computing device of claim 14, wherein the one or more classified object labels comprise one or more pedestrians, cyclists, automobiles, or trucks.
